(19) United States
(12) Patent Application Publication
(10) Pub. No.: US 2025/0315506 A1
(43) Pub. Date: Oct. 9, 2025

(54) DIGITAL CONTENT AND RIGHTS MANAGEMENT

(71) Applicant: Mark Bessett, Goodyear, AZ (US)

(72) Inventor: Mark Bessett, Goodyear, AZ (US)

(21) Appl. No.: 19/231,358

(22) Filed: Jun. 6, 2025

Related U.S. Application Data
(60) Provisional application No. 63/575,725, filed on Apr. 6, 2024.

(51) Int. Cl. G06F 21/10; G06F 21/16; H04L 9/00

(52) U.S. Cl. CPC G06F 21/105; G06F 21/1014; G06F 21/108; G06F 21/16; H04L 9/50

(57) ABSTRACT

Systems and methods for real-time micro-licensing of digital content (e.g., real estate listings, real estate records, ads, articles) are provided that comprise evolving documents and which use blockchains of cryptographic technology to employ smart contracts for the automatic issuance of micro-licenses upon digital content distribution, aligning with user subscription criteria and dynamically adjusting upon digital content revisions. Instantaneous, secure transactions and access rights adjustments in real-time are facilitated as content updates occur, ensuring continuous alignment with user preferences and legal compliance through transparent, auditable, blockchain records.

### CROSS-REFERENCE TO RELATED APPLICATIONS

This application claims the benefit of U.S. Provisional Application Ser. No. 63/575,725, filed on Apr. 6, 2024, which is hereby incorporated by reference herein.

### FIELD OF THE INVENTION

The invention relates to digital content and digital rights management (e.g., creation, tracking, protection, monitoring, enforcement, distribution, processing) and other processing using artificial intelligence (“AI”) in a smart contracts, blockchain-enabled ecosystem.

### BACKGROUND OF THE INVENTION

Digital content management, enforcement, distribution and other processing suffer from a number of limitations and constraints. In the past, this has mainly entailed physical contracts that lack the applicability and specificity of real-time agreements. This also lacked the ability to combine endorsements or data augmentation from authoritative sources. This provided no adequate method to advertise the availability of content (or advertisements) in a real-time and filterable manner that could meet license-filterable terms, including costs and trusted content. This also did not provide for an advertisable trust policy on trust and content for a site on a consumer-level specification or for additional filters applied by consumers.

These disadvantages apply in the management of licensing, acknowledging user preferences, legal compliance, and advertising integrity and authenticity. For example, existing content trustworthiness is not available at significant granularity. Digital content is not often searchable via the marketplace and there is often no provision for endorsements via the marketplace.

One such case is the National Association of Realtors' MLS, which provides digital content that is not sufficiently verifiable, transparent, or auditable. This creates trust inefficiencies and provides for only manual fact-checking.

With pressure to lower compensation, real-time licensing would provide new opportunities for new data products if they can overcome trust, transparency and auditability challenges. Better solutions for digital content management, enforcement and distribution are needed that address these problems.

### SUMMARY OF THE INVENTION

This invention solves many problems with past systems and methods and provides better solutions for digital content and rights management.

Certain preferred embodiments of this invention provide a dynamic blockchain-based system for real-time micro-licensing, tokenization, and advertising integrity in digital content management, including enforcement and distribution. Employing smart contracts for automatic micro-licensing aligned with evolving user preferences and legal compliance, it also leverages Non-Fungible Tokens (“NFTs”) to tokenize digital works, enhancing their credibility and marketability through authoritative endorsements. Furthermore, it changes the online advertising ecosystem by ensuring ad authenticity with a transparent ledger, leveraging artificial intelligence or AI for real-time ad vetting against truthfulness benchmarks, and providing a reversed revenue model that aligns economic incentives with integrity. This comprehensive solution addresses the challenges of licensing, managing, distributing, and monetizing evolving digital content and rights such as advertisements, offering a secure, efficient, and transparent method that benefits creators, consumers, advertisers, and publishers alike, providing a platform defined by truth, transparency, and trust in digital content, rights, and advertising.

Certain of the most preferred embodiments of this invention provide micro-license management and enforcement in a blockchain-enabled ecosystem with AI-enhanced adaptive data accuracy compliance and consumer trust.

In the past, physical contracts were used that lacked real-time agreement, and provided no ability to combine endorsements or data augmentation from authoritative sources. There was no way to advertise in a real-time filterable manner, the availability of content (or advertisements) that meet license-filterable terms, including costs, with trusted content. Certain preferred embodiments of this invention solve these problems and also provide for a consumer-level specification of trust and content so that in addition to an advertisable trust policy for content by a site, consumers can apply any additional filters that would be beneficial.

Certain of the preferred embodiments of this invention provide real-time, filterable license terms with implicit data distribution; blockchain-backed transparency and audibility; self-moderating trusted review and content via endorsements for content; and traceable license misuse detection.

Computer executable functions that are stored on a computer device (e.g., a remote server) that run on a smartphone or any other device that connects to the computer device with data that either stores it or processes it to be used on a mobile phone.

Particularly preferred embodiments of this invention introduce an advanced blockchain-based micro-licensing system that leverages NFTs to revolutionize digital content management and distribution. These embodiments enable content creators to tokenize their digital works as unique NFTs, with embedded licensing terms and conditions ensured by smart contracts. They facilitate a dynamic marketplace where content can be reviewed and endorsed by authoritative sources, with such endorsements recorded within the NFTs, enhancing content credibility and value. This integration of NFTs not only simplifies the licensing and transaction processes but also ensures compliance with digital rights management and increases content marketability. The platform supports a transparent revenue-sharing model, incentivizing content creation and authoritative endorsements. By combining the immutable nature of blockchain with the uniqueness of NFTs and the credibility of expert endorsements, certain embodiments of this invention offer a comprehensive solution for managing, distributing, and monetizing digital content in a secure, transparent, and efficient manner.

Particularly preferred embodiments of this invention also introduce a groundbreaking framework designed to revolutionize the online advertising ecosystem by ensuring the authenticity and integrity of advertisements published on the internet. Leveraging the immutable nature of blockchain technology, NFTs, and the analytical power of AI, these embodiments establish a transparent, verifiable ledger for each advertisement. Ads are tokenized as NFTs, each embedded with a unique digital fingerprint that records their content, origin, and any modifications, ensuring accountability and facilitating easy verification of their authenticity.

A key innovation of these preferred embodiments is its AI-driven mechanism for real-time analysis and vetting of advertisements against established benchmarks for truthfulness. This automated process allows for the certification of ads, providing publishers with the confidence to select and host advertisements that meet rigorous standards of accuracy. Furthermore, the system reimagines traditional ad revenue models by reversing the payment flow; advertisers can compensate publishers for hosting certified, and independently-verified, advertisements, aligning economic incentives with the promotion of integrity and trust in digital advertising. The trust extends from the publisher to the consumer, each with their own uniquely filterable content exposure.

The benefits of this system extend to all stakeholders in the digital advertising space. Consumers gain access to reliable and verified advertising content, enabling more informed decision-making. Advertisers achieve a trusted platform for their campaigns, enhancing their credibility and effectiveness. Publishers, in turn, ensure the quality and integrity of the content they host, safeguarding their reputation and fostering trust with their audience.

This invention not only addresses the critical challenge of misinformation in online advertising but also introduces a sustainable, trust-based model for ad distribution and monetization. It represents a significant leap forward in digital advertising, promising a future where truth, transparency, and trust define the advertising landscape.

The field of this invention encompasses digital rights management (DRM), focusing on the innovative use of blockchain technology to facilitate a comprehensive micro-licensing ecosystem. This system is designed to address and rectify longstanding issues within DRM by providing a transparent, secure, and flexible framework for managing and distributing digital content rights. Central to this invention is the integration of NFTs for representing digital artifacts uniquely, ensuring traceability and ownership while also enabling a decentralized market for content licensing and sales.

The invention significantly enhances traditional DRM approaches by introducing several key features:

1. Micro-Licensing Through Blockchain: At the heart of certain preferred embodiments is the concept of micro-licenses, which are managed through smart contracts on a blockchain. This setup not only guarantees the immutability and transparency of licensing agreements but also automates the enforcement and compliance of these agreements, minimizing the need for intermediaries and reducing potential conflicts.

2. Community-Driven License Templates: Recognizing the diverse needs of content creators and consumers, certain preferred embodiments empower their community to contribute and vote on predefined licensing templates. This democratically sourced library of templates ensures that users can quickly find and apply the most suitable licensing terms for their content, fostering innovation and compliance across the ecosystem.

3. Authoritative Endorsements and Content Fingerprinting: To further enhance trust and credibility within the ecosystem, certain preferred embodiments incorporate mechanisms for authoritative endorsements and content fingerprinting. Authoritative endorsements provide third-party validation of content, adding an extra layer of credibility. Meanwhile, content fingerprinting allows for unique identification and tracking of content, aiding in the detection and prevention of unauthorized use.

4. Adaptive AI for License Compliance and Enforcement: Leveraging machine learning and artificial intelligence, certain preferred embodiments continuously monitors and learns from content usage patterns. This adaptive approach enables the dynamic detection of licensing violations and automates the disposition of such violations, ensuring that the ecosystem evolves in response to emerging challenges and trends.

5. Application Across Various Sectors: While certain preferred embodiments have a detailed application within the real estate sector, showcasing its capability to revolutionize property listings, document management, and transaction records, it is designed to be adaptable across various fields. This versatility underscores the system's potential to transform DRM practices in industries ranging from digital media and entertainment to education and beyond, wherever digital content needs to be managed, shared, and protected.

In essence, this invention proposes a paradigm shift in how digital content is licensed, shared, and monitored, moving away from opaque and rigid systems to a model that promotes openness, flexibility, and collaboration. By harnessing the power of blockchain, NFTs, and AI, it sets a new standard for digital rights management, offering a scalable, secure, and user-centric approach that could redefine the landscape of digital content across multiple sectors.

The embodiments of this invention are deeply rooted in addressing the challenges and limitations of traditional DRM systems, particularly in the context of licensing digital content and artifacts.

Traditional DRM systems, while attempting to protect copyright and manage access to digital content, often suffer from rigidity, lack of transparency, and inefficiency. These systems typically fail to accommodate the dynamic nature of digital content distribution, struggle with interoperability, and do not provide a mechanism for equitable revenue sharing or community engagement. Furthermore, traditional approaches lack the means to verify content authenticity or endorse the quality and accuracy of information, which is especially critical in sectors like real estate where the value and utility of content heavily depend on its credibility.

Key challenges identified in the systems used in the past include:

1. Opacity in Transactions: Traditional systems do not offer sufficient transparency regarding the terms of content licenses, transactions, and the history of digital artifacts. This opacity can lead to disputes, mistrust, and inefficiencies in content distribution and usage.

2. Inflexible Licensing Models: The one-size-fits-all approach of many DRM systems does not cater to the diverse needs of content creators and users, limiting the potential for innovative use cases and fair compensation.

3. Centralization and Security Concerns: Centralized DRM solutions present security vulnerabilities and risk data manipulation or loss. They also create bottlenecks and dependencies on single entities for managing rights and access.

4. Lack of Verifiable Endorsements: There's no systematic way to incorporate authoritative endorsements into digital content, making it difficult for users to assess the reliability and accuracy of the information, particularly in data-sensitive industries like real estate.

5. Difficulty in Rights Enforcement: Enforcing licensing terms and addressing violations in a timely and effective manner is challenging with traditional DRM, often requiring manual intervention and lacking mechanisms for automatic detection and resolution of issues.

The invention emerges from a critical analysis of these challenges, proposing a novel solution that leverages blockchain technology, NFTs, and AI. The solutions provided by certain embodiments of this invention aim to redefine digital rights management by introducing micro-licenses for digital artifacts, facilitating transparent, flexible, and secure transactions and interactions within a decentralized or centrally managed, transparent blockchain framework. The system's design encourages community participation in creating and selecting licensing templates, enables authoritative endorsements to verify content, and employs AI to automate compliance monitoring and enforce licensing terms effectively. This innovative approach not only addresses the inherent flaws of traditional DRM systems but also opens up new possibilities for content creation, distribution, and monetization across various sectors, with an illustrative focus on the real estate market.

The most preferred embodiments of this invention introduce a groundbreaking blockchain-based micro-licensing system that redefines the management and distribution of digital content across various industries, with a notable application in the real estate sector. At its core, these embodiments employ NFTs to tokenize digital artifacts, ensuring each piece of content is uniquely identified, owned, and securely transacted on the blockchain. This approach not only secures copyright and ownership data but also embeds flexible, transparent licensing terms directly within the NFT metadata. A significant innovation is the incorporation of community-driven licensing templates, which allows users to select from pre-defined licensing agreements or customize them according to specific needs, thereby streamlining the licensing process and promoting standardization.

Further enhancing these embodiments and their credibility and utility are authoritative endorsements, where verified experts or institutions can validate the content's accuracy or authenticity, with such endorsements being recorded within the NFTs. This feature is particularly transformative in real estate, where the veracity of property listings and documents is paramount. These embodiments also leverage AI and machine learning (ML) to automate the detection of license term violations and adapt enforcement mechanisms, ensuring compliance and simplifying the management of digital rights.

A pivotal functionality of these embodiments is their automated violation management process, which intelligently handles breaches in licensing agreements using blockchain-recorded evidence and AI-driven decision-making. This ensures that any unauthorized use is promptly and fairly resolved, maintaining the integrity of the licensing system.

One of the most user-centric features is the mechanism for implicit acceptance of contract terms through interaction with push notifications. When new or updated content becomes available, users receive a notification inviting them to access the content. By responding to this notification via an API-essentially a simple action such as clicking a link or button in the notification-users automatically agree to the associated licensing terms, streamlining access to the content. This process not only facilitates ease of use but also ensures that users are informed and consent to the terms of use in real-time, further emphasizing these embodiments' commitment to transparency and user empowerment. In summary, certain embodiments of this invention offer a sophisticated, blockchain-enhanced framework for digital content licensing and distribution, marked by its use of NFTs, community-curated licensing templates, authoritative endorsements, and advanced AI capabilities. It promises to revolutionize the digital rights management landscape, providing a secure, transparent, and efficient platform for content creators, licensors, and users alike, with the added advantage of facilitating implicit contract acceptance and access to digital artifacts through interactive notifications. Certain key components and/or features of these embodiments comprise:

1. Blockchain-Based System: Utilizes blockchain technology to create a centralized or decentralized ledger for recording licenses, transactions, and endorsements, ensuring transparency, security, and immutability.

2. Micro-Licensing with NFTs: Introduces a micro-licensing approach where digital artifacts are tokenized as NFTs. This allows for precise management of licensing terms, ownership tracking, and transaction history directly within the NFT metadata.

3. Community-Driven Licensing Templates: Empowers the community to contribute to and select from a library of pre-defined licensing templates. This fosters standardization while providing flexibility to accommodate diverse use cases and preferences.

4. Authoritative Endorsements: Incorporates a mechanism for content to be verified and endorsed by recognized authorities or experts. Endorsements are embedded within the NFTs, enhancing the content's credibility and market value.

5. AI and Machine Learning for Compliance: Leverages AI and machine learning technologies to automate the detection of licensing term violations and adapt enforcement strategies. This ensures effective compliance and rights management.

6. Automated Violation Management: Outlines an automated process for handling licensing violations, using blockchain records for evidence and AI to determine the most appropriate actions, improving efficiency and fairness in dispute resolution.

7. Customizable and Dynamic Licensing: Allows licensors to customize terms on top of the selected templates and dynamically adjust licensing agreements in response to changes in content usage or market conditions.

8. Content Marketplace: Facilitates a transparent and open marketplace for buying, selling, or licensing digital content, supported by blockchain technology to ensure fair and secure transactions.

9. Transparent Revenue Sharing Models: Implements smart contract-based revenue distribution models, enabling fair compensation for content creators, licensors, and endorsers based on agreed terms.

10. Information Verification Model: An advertisement use case of trusted endorsement usage represents a significant advancement in digital advertising, addressing critical challenges of trust and verifiability. By integrating trusted endorsements within a blockchain-enabled framework and employing smart contracts for ongoing validation, and real-time verification, this approach not only enhances the credibility of online advertisements but also fosters a more transparent and trustworthy advertising ecosystem. The inclusion of dynamic consumer feedback, economic incentives for quality ad placement, and automated compliance monitoring further underscores the innovation and advantages of this system over conventional advertising methods, making it a pivotal addition to the current patent application.

11. End-Consumer controls interacting with the verification network: Incorporating browser plugins or capabilities that allow consumers to filter and interact with digital content based on trusted endorsements represents a paradigm shift in online content consumption. By providing consumers with the tools to tailor their digital environment to align with personal standards of trustworthiness and accuracy, this approach significantly enhances consumer agency, promotes a healthier digital ecosystem, and establishes a new benchmark for content integrity and reliability. This detailed functionality of browser plugins, as part of the patented system, underscores the commitment to leveraging technology for empowering consumers and fostering trust in digital content.

Applications for the embodiments of this invention are disclosed herein or apparent to a person of skill in the art reading this specification. These applications can include, for example, real estate data sharing, news and non-fiction articles, instructional content, and advertisements. The person of ordinary skill in the art understands how these embodiments and combining of this invention to these uses can be done with, for example, digital content and rights in general.

Advantages of the embodiments of this invention are described and apparent throughout this specification. For example, certain embodiments facilitate instantaneous, secure transactions and access rights adjustments in real-time as content updates occur. Certain embodiments ensure continuous alignment with user preferences and legal compliance through transparent, auditable blockchain records. This approach of certain embodiments addresses the challenges of licensing evolving digital content, providing a secure, transparent, and efficient method of digital rights management that benefits content creators and consumers alike by enabling the tailored distribution and continuous updating of content. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items. The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

The accompanying drawings, which are incorporated in and constitute a part of this specification, illustrate one or more embodiments of the invention and, together with the description, explain the invention. The present disclosure will become more fully understood from the detailed description and the accompanying drawings, wherein:

FIG. 1 is flowchart of a create artifact flow embodiment of the invention.

FIG. 2 is flowchart of a publish artifact flow embodiment of the invention.

FIG. 3 is flowchart of an acquire licensed artifact/content embodiment of the invention.

FIG. 4 is flowchart of a changed artifact flow embodiment of the invention.

FIG. 5 is flowchart of an artifact endorsement request flow embodiment of the invention.

FIG. 6 is flowchart of an endorse artifact fulfillment embodiment of the invention.

FIG. 7 is flowchart of a license expiration/revocation flow embodiment of the invention.

FIG. 8 is flowchart of an advertiser trust proxy via endorser embodiment of the invention.

FIG. 9 is flowchart of a site owner acquisition of trusted advertisements embodiment of the invention.

FIG. 10 is flowchart of a consumer client auto-moderated content embodiment of the invention.

FIG. 11 is flowchart of an automated license validation/verification embodiment of the invention.

FIG. 12 is flowchart of a violation reporting embodiment of the invention.

FIG. 13 is a block diagram of an exemplary computing device that may be used to implement various aspects of the invention.

### DETAILED DESCRIPTION OF THE INVENTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The invention will be described in detail with reference to certain preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

The following description is merely illustrative in nature and is in no way intended to limit the disclosure, its application, or uses. For purposes of clarity, the same reference numbers will be used in the drawings to identify similar elements. As used herein, the phrase “at least one of” A, B, and C should be construed to mean a logical (A or B or C), using a non-exclusive logical OR. It should be understood that steps within a method may be executed in different order without altering the principles of the present disclosure. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Certain embodiments of this invention can provide micro-license management and enforcement in a blockchain-enabled ecosystem with AI-enhanced adaptive data accuracy compliance and consumer trust.

Systems and methods for real-time micro-licensing of digital content are provided that comprise evolving documents and which use blockchains of similar cryptographic technology to employ smart contracts for the automatic issuance of micro-licenses upon content distribution, aligning with user subscription criteria and dynamically adjusting upon content revisions. Instantaneous, secure transactions and access rights adjustments in real-time are facilitated as content updates occur, ensuring continuous alignment with user preferences and legal compliance through transparent, auditable blockchain records.

A “micro-license” in the context of this invention with blockchain and smart contracts refers to a small, granular digital license that is encoded within a smart contract, which permits the precise and automated distribution of usage rights for digital content, with the ability to track and manage individual usage and enabling fine scale pay for use licensing models. Important aspects of micro-licenses include the ability for granular control of assets, automated enforcement, transparency and traceability, and micro-payments. The term and subject matter of a “micro-license” is also referred to herein as a “license”, because a “micro-license” is a type of license.

Certain preferred embodiments of this invention provide for real-time, filterable license terms with implicit data distribution. These embodiments provide for blockchain-backed transparency and auditability. They also provide for self-moderated trusted review and content via endorsement for content and license misuse detection.

In certain preferred embodiments of this invention, smart contracts play a central role in creating, managing, and enforcing licenses for digital content, including documents and their revisions. These smart contracts are deployed on a blockchain platform, ensuring transparency, security, and immutability.

### CERTAIN COMPONENTS OF THESE PREFERRED EMBODIMENTS

These preferred embodiments of this invention comprise several components, including some or all of the following:

### 1. Verifiable User and Credential Information

Content contributors and licensees may have credential requirements for some use cases. Where applicable, this includes any state or local licenses, ownership records, or affiliations. This supports roles that have impact on licensed use or roles in contracts and other support as necessary to comply with laws and regulations, contractual and licensable use.

### 2. Repository for Artifacts

Repository for digital artifacts, including compilation of Json data, photographs, video, contracts, drawings, diagrams, marketplace events and other items suitable for distribution and syndication.

### 3. Creation and Issuance of Licenses

When a new piece of content is created and ready for distribution, a corresponding smart contract is deployed to the blockchain. This smart contract contains the terms of the license, such as the allowed uses of the content, the duration of the license, and the price. When a user wishes to access the content and agrees to these terms, the smart contract automatically processes the transaction: it verifies the payment, issues the license, and records the transaction on the blockchain. This ensures that the issuance of licenses is immediate, transparent, and error-free.

### 4. Real-Time Licensing and Subscription Matching

Smart contracts facilitate real-time licensing by constantly monitoring for matches between available content and user subscriptions. When a piece of content matches a user's subscription criteria (such as topic, length, or format), the smart contract automatically initiates the licensing process. If the content is updated or revised, the smart contract also assesses whether the updated version still fits the criteria of existing subscriptions and, if so, automatically updates the licenses to cover the new version, ensuring continuous access for the user.

### 5. Automated Adjustments and Renewals

As content evolves, its licensing needs may change. Smart contracts can be programmed to handle these changes dynamically. For example, if a document is updated with new chapters or revised information, the smart contract can automatically notify existing license holders of the update and, based on the user's subscription model, either grant access to the new content, prompt the user to extend their license, or adjust the license terms accordingly.

### 6. Audit Trails and Transparency

Every transaction and interaction with the smart contract is recorded on the blockchain, creating an immutable audit trail. This includes the initial licensing transactions, any adjustments made to the license (such as extensions or updates due to revised content), and access logs. This transparency ensures that all parties can verify the history and terms of the license at any time, fostering trust and compliance.

### 7. Enforcement of Licensing Terms

Smart contracts enforce the terms of the licenses automatically. For instance, if a license restricts the use of the content to a certain number of views or a specific time period, the smart contract monitors this usage and ensures compliance. If the terms are violated, the smart contract can automatically revoke access, enforce penalties, or notify the content creator.

### 8. Handling of Payments and Royalties

The smart contracts also manage the financial transactions associated with licensing. They ensure that payments made by users are securely transferred to the content creators. Additionally, if the content generates royalties (for example, every time it is viewed or cited), the smart contract automatically calculates and distributes these royalties according to the predetermined terms.

### 9. Blockchain Infrastructure and Smart Contracts

The core of the system is built on a blockchain platform, ensuring data integrity, transparency, and security. Smart contracts automate various processes, including license issuance, payments, and enforcement of terms. Each piece of content is linked to a unique smart contract that defines its licensing terms.

### 10. Artifact Endorsements and Augmentation

Endorsements can be sought, supplied and integrated in a trusted way providing value to all consumers, and mitigate both intentional and unintentional misrepresentation, and intrinsic citing of information source. This also provides a measure of risk mitigation for the author.

### 11. User and Content Management

The system includes interfaces for content creators to upload and manage their content and for users to set their subscription preferences. Digital fingerprints and metadata are used to track and manage content, ensuring proper attribution and rights management.

### 12. Subscription Matching and Notifications

Smart contracts automatically match new or updated content with user subscriptions. When a match occurs, the system sends a push notification to the user, prompting them to review the content and complete the licensing transaction. This process leverages user data and content metadata for efficient matching.

### 13. Licensing and Payment Process

Upon receiving a notification, the user can acknowledge interest in the content directly through the push notification interface. This acknowledgment triggers the associated smart contract, which then processes the license agreement and payment. The system supports various payment models, including one-time payments, subscriptions, and usage-based fees.

### 14. Access and Usage Tracking

Once the licensing transaction is completed, the user gains access to the content under the agreed terms. The system tracks usage and ensures compliance with the licensing terms. Unauthorized use or distribution triggers automatic enforcement actions based on the smart contract.

### 15. Revocation and Updates

The system allows for the revocation of licenses under specific conditions, such as breach of terms or expiration. It also handles content updates, ensuring that licenses remain valid for updated versions if applicable.

### 16. Security and Compliance

Security measures are in place to protect user data and content, including encryption and secure authentication. The system complies with relevant regulations, such as copyright laws and data protection standards.

### 17. Optimization and Interaction

The integration of push notifications and direct smart contract interactions streamlines the licensing process, reducing the need for multiple steps and interactions across the internet. This optimization enhances user experience and system efficiency.

Specifically after subscription-based notification of available content and filtered license terms, a subscriber can elect to receive the content thereby initiating license and acceptance of terms, payment execution, and download of the content itself. The content is fingerprinted with individual terms for verification.

By leveraging smart contracts in these ways, the micro-licensing feature of this invention ensures that the process of licensing digital content, including managing revisions and updates, is automated, secure, and transparent. This automation reduces administrative overhead, minimizes errors, and provides a clear, auditable trail of all transactions and interactions with the licensed content.

### License and License Template Definition

Licenses are generated dynamically for each artifact to accommodate the varied terms set by different authors and creators. This necessitates specifying license terms in advance, but applying them only at the moment of creation, with each license uniquely linked to both the artifact and its recipient. To facilitate this process, a system of license templates is used. These templates enable the predefined terms to be effectively applied to artifacts upon distribution, allowing for a customization mechanism within the subscription model. Consequently, consumers can streamline the acquisition of artifacts, selectively downloading those that align with their specific requirements and budgetary constraints through an automated process.

Incorporating blockchain technology into this licensing framework introduces an additional layer of security and transparency. By leveraging blockchain, each dynamically generated license agreement, created in real-time for individual artifacts, can be recorded on a decentralized ledger. This immutable record ensures that the terms of the license, along with the identities of both the content creator and the consumer, are securely and permanently logged.

Blockchain's inherent properties of transparency and tamper-resistance offer several benefits. First, they facilitate trust among parties, as all transactions (including the creation of licenses) are verifiable by all participants in the network. This reduces the potential for disputes over licensing terms or copyright infringement, as the blockchain provides a clear, unalterable history of licensing transactions.

Additionally, the use of smart contracts on the blockchain can automate the enforcement of licensing terms. These self-executing contracts with the terms of the agreement directly written into code can automatically manage the distribution and licensing of artifacts based on the conditions predefined in the license templates. This not only enhances efficiency by reducing manual oversight but also ensures compliance with the licensing terms set by creators.

Moreover, the blockchain's capability for fine-grained access control can support a more nuanced licensing model. For instance, licenses can be designed to automatically adjust terms based on the consumer's usage or to enable features such as time-based access or subscription models.

Integrating blockchain into the licensing process ultimately adds value by providing a secure, transparent, and automated system for managing and enforcing digital licenses, tailored to the specific needs and terms of creators and consumers alike.

### Community License Templates

License templates can also be introduced by marketplace participants. This natural consensus model offers a way for the marketplace to develop and define standardized terms, while still providing an open, transparent model for new ideas and innovations, as well as natural adaptation to new artifact types, use cases, and new classes of participants.

Standardized, and adaptable terms allow for a dynamic model of subscription filters that adapt and address new artifact types while retaining existing license subscription infrastructure and automated license acceptance and purchase. Furthermore, it allows standards to evolve freely providing competition and encourage an open marketplace, rendering a natural barrier to monopolistic business practices.

### License Expiration and Renewals

In the sophisticated ecosystem designed to manage digital rights through blockchain technology, a critical component is the handling of license expiration and renewal. This mechanism is vital for maintaining the integrity and relevance of licensing agreements over time, ensuring they continue to meet the evolving needs of content creators, publishers, and consumers. The invention's preferred approach to license expiration and renewal is both robust and user-centric, leveraging the blockchain's capabilities for transparency, security, and efficiency.

When a digital content license is initially created and agreed upon, its terms, including the duration of the license, are encoded into a smart contract associated with the content's Non-Fungible Token (NFT). This smart contract, residing on the blockchain, autonomously monitors the license term, ensuring that all parties adhere to the agreed-upon conditions. As the expiration date approaches, certain of these embodiments initiate a series of automated notifications to both the content provider and the licensee, alerting them to the impending license expiration. This proactive communication ensures that there is ample time for consideration and action regarding license renewal, avoiding any disruption in content access or usage.

The renewal process itself is designed to be as seamless as possible. Upon receiving notification of impending license expiration, the licensee has the option to initiate a renewal directly through the interface that is provided. This action triggers the corresponding smart contract, which then presents the licensee with the current terms of renewal. It is important to note that these terms can be dynamically adjusted by the content provider to reflect changes in content value, market conditions, or usage rights, ensuring that the renewal agreement is both current and mutually beneficial.

If the licensee agrees to the updated terms, the renewal process proceeds with the smart contract automatically updating the license term on the blockchain. This updated record is immutable, providing a transparent and secure ledger of the renewed agreement. In instances where the licensee opts not to renew the license or if the content provider decides not to offer renewal, the smart contract enforces the license expiration, effectively revoking access to the content in accordance with the original agreement.

Furthermore, the system accommodates scenarios where automatic renewals are preferred by both parties. In such cases, the smart contract can be configured to automatically renew the license upon expiration, provided that all predefined conditions for renewal are met. This option offers convenience and continuity for long-term agreements, minimizing administrative overhead and ensuring uninterrupted access to content.

In all instances of license expiration and renewal, these preferred embodiments prioritize transparency, security, and user autonomy. By embedding these processes within the blockchain and smart contract infrastructure, these embodiments ensure that license management is not only efficient but also adaptable to the specific needs and preferences of all stakeholders involved. This approach significantly enhances the digital rights management landscape, offering a reliable and scalable solution for managing the lifecycle of content licenses in the digital age.

### License and Data Artifact Non-Fungible Tokens (NFTS)

Extending the licensing concept of certain embodiments of this invention to Non-Fungible Tokens (NFTs) introduces a novel approach to digital ownership and rights management, further enhancing the security, uniqueness, and transferability of licenses. NFT-based licenses can revolutionize how digital artifacts and their associated rights are distributed, tracked, and authenticated. Here are several benefits of incorporating NFTs into the licensing framework:

1. Provable Ownership and Authenticity: NFTs can represent digital licenses as unique, verifiable assets on the blockchain. This ensures that each license, like the digital artifact it's associated with, is one-of-a-kind and cannot be duplicated, providing clear proof of authenticity and ownership. This is particularly valuable in digital art, software, and media distribution, where proving the provenance and ownership of digital content is critical.

2. Transferability and Secondary Markets: NFT-based licenses facilitate easier and more secure transfer of licenses between parties. Because NFTs are designed to be easily transferable while ensuring the integrity of the asset they represent, they enable the creation of legitimate secondary markets for digital artifacts. Creators can also receive royalties from secondary sales automatically, as these terms can be coded into the NFTs, ensuring continuous compensation for their work.

3. Interoperability Across Platforms: The standardized nature of NFTs allows for greater interoperability across different platforms and marketplaces. This means that NFT-based licenses could be recognized and utilized across various ecosystems, making it simpler for consumers to access and use digital artifacts across multiple services without the need for separate licensing agreements.

4. Enhanced Consumer Experience: For consumers, NFT-based licenses can offer more dynamic and interactive experiences with digital artifacts. For instance, owning a particular NFT license could unlock special features or content within a digital platform, offering a personalized experience based on the specific licenses held by the consumer.

5. Increased Transparency and Reduced Piracy: The transparency of the blockchain ensures that the issuance, transfer, and terms of NFT-based licenses are publicly verifiable. This can significantly reduce piracy and unauthorized distribution, as each transaction and license ownership is recorded on the blockchain, making unauthorized copies easy to identify and challenge.

6. Innovative Licensing Models: NFTs open up possibilities for new licensing models that were previously difficult or impossible to implement. For example, licenses could be issued as NFTs that expire after a certain period or after a certain number of uses. Alternatively, licenses could grant different levels of access or privileges based on the specific NFT held by the consumer.

By integrating NFTs into the licensing framework, creators and consumers can benefit from a more secure, transparent, and flexible system for managing digital rights and ownership. This innovative approach can lead to new forms of digital engagement and monetization, further empowering creators and enhancing the consumer experience.

### Violation Detection

Detecting and addressing violations of license and contract terms, especially in the context of digital content and blockchain, can be complex but manageable within certain embodiments of this invention. These embodiments comprise the following components and/or features:

1. Automated Monitoring and Alerts: Automated monitoring processes are implemented that track how licensed content is being used. This involves software that checks the digital fingerprint of content across the web or within specific networks. If unauthorized use is detected, the system can automatically alert the content owner or initiate predefined responses. Methods such as web scraping, and techniques used to extract data from websites, can be used. It involves programmatically accessing web pages and extracting useful information from the HTML content. This process is automated using software or scripts that simulate human web browsing to collect specific data. The extracted data can then be analyzed, stored, displayed and/or acted upon.

2. Smart Contract Enforcement: Smart contracts are designed to include mechanisms for monitoring compliance with license terms. For example, if a license restricts access to a certain number of users or views, the smart contract can automatically enforce these restrictions and revoke access if they are exceeded. This is done by requiring certain contents in the displayed digital data, including “fingerprints” whereby displayable content is hashed together with the contract id linking the licensee and terms.

3. Cryptographic Watermarking: Cryptographic watermarks or digital fingerprints can be embedded in licensed content. These are not noticeable during regular use but can be used to trace the content back to the source if it is found in unauthorized locations or in a manner that violates the terms of the license. This helps in identifying breaches of contract terms.

4. Audit Trails: Blockchain's inherent audit trail capabilities allow the tracking the distribution and use of content. Since transactions on a blockchain are immutable, they provide a clear and tamper-proof history of how each piece of content has been used, making it easier to identify and prove violations.

### Machine Learning Detection of Misuse

The integration of Machine Learning (ML) for the detection of license misuse represents a significant advancement in safeguarding digital content rights within the most preferred embodiment of this invention. This innovative approach leverages automated processes to monitor and validate the usage of licensed content across the web, ensuring compliance with the established licensing agreements. At the core of this process is the concept of digital fingerprinting, a unique identifier embedded in the content that allows for precise tracking and verification of its distribution and use.

The mechanism begins with the licensee declaring a specific URL where the licensed content will be hosted. Upon publication, the licensed content's digital fingerprint is discretely embedded within the webpage, often through an HTML header or another non-visible method, ensuring it does not alter the user's experience or the content's presentation. This digital fingerprint serves as a verifiable marker of the content's authenticity and licensing status.

The system's ML algorithm plays a crucial role in continuously scanning the web for instances of the fingerprinted content. By analyzing web pages for the presence of these unique digital fingerprints, the algorithm can accurately determine whether the content is being used within the terms of the license agreement. If the algorithm detects the fingerprinted content on unauthorized URLs or in contexts that violate the licensing terms, it flags these instances as potential violations, initiating a review process.

Conversely, the algorithm is also adept at identifying unlicensed use of content. This is achieved by searching for specific hashed fields related to the content that should be accompanied by a valid digital fingerprint. If these fields are detected without the corresponding fingerprint, it indicates that the content is being used without proper licensing-a clear breach of copyright and licensing agreements.

An essential feature of this ML-driven process is its capacity for continuous learning and improvement. As additional instances of misuse are reported or identified, the algorithm assimilates this data, refining its detection capabilities. This adaptive learning process enhances the algorithm's accuracy and efficiency over time, enabling it to stay ahead of evolving tactics employed to circumvent digital content rights.

This ML detection mechanism not only automates the labor-intensive process of monitoring for license misuse but also significantly increases the scope and effectiveness of these efforts. By providing a scalable, automated solution for validating content usage and identifying violations, the system empowers content creators and licensors to protect their rights and intellectual property in the digital arena more effectively. Furthermore, the integration of ML for license misuse detection underscores the system's commitment to leveraging cutting-edge technology to address the challenges of digital rights management, offering a robust, future-proof solution for ensuring content integrity and compliance.

A machine learning algorithm designed to detect misuse of licensed digital content typically involves several steps and components. The algorithm works as follows:

1. Data Collection: First, the algorithm requires a dataset of user behaviors and content interactions. This includes legitimate uses of content under license terms and instances of misuse or violation, such as unauthorized sharing or access beyond the agreed terms. Data could also include timestamped logs of access, user interaction patterns with the content, and digital fingerprint detections.

2. Feature Extraction: From this data, the algorithm extracts relevant features that help differentiate between proper use and misuse. Features might include frequency of access, types of interactions (e.g., view, download, share), access locations, time spent with the content, and the presence of digital fingerprints in unauthorized locations.

3. Model Training: Using the collected data and extracted features, the algorithm is trained to identify patterns of misuse. Common machine learning models for this purpose could include decision trees, support vector machines (SVM), or neural networks. The choice of model depends on the complexity of the task and the nature of the data. The training process involves adjusting the parameters of the model to minimize the error between its predictions and the actual data labels (legitimate use vs. misuse).

4. Validation and Testing: After training, the model is validated and tested using a separate set of data not seen by the model during training. This step is crucial to evaluate the model's accuracy and its ability to generalize to new, unseen examples. Performance metrics such as precision, recall, and F1 score are used to assess the effectiveness of the model in detecting misuse.

5. Deployment: Once validated, the model is deployed within the content management system. As part of the system, it continuously analyzes user behavior and content interaction patterns. When the model identifies a likely misuse based on the learned patterns, it triggers an alert for further investigation or automatic enforcement actions, depending on the system's design.

6. Continuous Learning: Over time, the algorithm can be retrained and updated with new data reflecting evolving usage patterns and emerging forms of misuse. This process, known as retraining or fine-tuning, helps the model stay effective even as conditions change.

7. Feedback Loop: To ensure fairness and reduce false positives, the system includes a feedback mechanism where users can contest misuse allegations. Feedback from these cases can be used to further refine and train the model, improving its accuracy.

### Exemplary Machine Learning Algorithm-Decision Tree

As an example, a decision tree algorithm could be used for misuse detection. The tree's branches represent the features extracted from the data (e.g., number of times content was accessed), and the leaves represent the outcomes (legitimate use or misuse). The algorithm splits the data at each node based on feature values that most effectively separate misuse from legitimate use, creating a tree structure that can classify new instances based on their features.

Note: Implementing such an algorithm involves careful consideration of privacy and ethical standards, particularly when handling user data. It is important to comply with all relevant regulations and standards, such as GDPR for users in the European Union.

Utilizing a machine learning approach provides a dynamic and adaptive method for detecting misuse of licensed digital content, allowing for more effective and timely enforcement of licensing terms.

### Automated Violation and Dispute Process

The Violation Adjudication and Dispute Flow within our innovative digital rights management invention incorporates an advanced Language Model (LLM) AI assistant designed to streamline the resolution of licensing violations and disputes. This AI assistant represents a significant enhancement in the management of digital content rights, employing a sophisticated combination of automated processes and human oversight to address violations effectively and efficiently.

Upon detection of a potential licensing violation—either through machine learning algorithms that monitor content usage across the web or through reports submitted by content creators, licensors, or the public—the LLM AI assistant initiates the adjudication process. This process begins with the AI assistant sending automated email notifications to the parties involved, alerting them to the potential violation and requesting any additional information necessary to assess the situation. These communications are crafted to be clear and concise, ensuring that recipients understand the nature of the potential violation and the actions required on their part.

The AI assistant is programmed to evaluate the responses and additional information provided by the involved parties against the established licensing terms and the specifics of the reported violation. When the criteria for a violation are clearly met or contradicted based on the information gathered, the AI assistant can take predetermined automated actions. These actions may include revoking content access, adjusting licensing terms, or implementing penalties as stipulated in the original licensing agreement.

However, recognizing the complexity of digital rights management and the nuances that can accompany licensing disputes, the system is designed to escalate issues to a manual process when automated actions are not sufficiently justified by the available information. In such cases, the dispute is referred to human experts for a more detailed review. These experts assess the situation, considering the context, the intent, and any extenuating circumstances that may influence the resolution of the dispute. This hybrid approach, combining AI-driven efficiency with human judgment, ensures that disputes are resolved fairly and with a thorough understanding of the nuances involved.

The LLM AI assistant also plays a crucial role in learning from each adjudication and dispute resolution process. By analyzing outcomes and the decision-making paths taken, the AI assistant continuously refines its criteria for automated actions, improving its accuracy and effectiveness over time. This adaptive learning capability ensures that the system evolves in response to new challenges and emerging trends in digital content management.

In summary, the Violation Adjudication and Dispute Flow implemented with an LLM AI assistant offers a dynamic and responsive solution to managing licensing violations and disputes in the digital realm. By balancing automated processes with the option for manual review and incorporating continuous learning, this system significantly advances the capabilities of digital rights management, ensuring that content creators and licensors can protect their rights while fostering a fair and transparent digital ecosystem.

### General Violation Adjudication and Dispute Flow

The following is an example of a process and method for taking action when violations of licensing terms occur, involving notifications to the content creator, the user who violated the terms, and a third-party network administrator as warranted

1. Violation Detection: The system (embodiment), utilizing the machine learning algorithm or other mechanism, identifies a potential violation of the licensing terms.

a. This could be unauthorized distribution, excessive access, or other forms of misuse as defined by the licensing agreement which can be automatically discovered

b. Reported by others. When reported by others, AI chatbots can take the report, and kick off the flow and processes.

2. Initial Verification: Before any notifications are sent, the system performs an initial verification to confirm the violation. This step reduces false positives and ensures that the detected activity genuinely contravenes the licensing terms. The verification process may analyze additional data or apply more stringent criteria to confirm the misuse.

3. Record and Log: Once a violation is confirmed, the system logs the details, including the nature of the violation, the identity of the user, time stamps, and any other relevant information.

This record will be essential for further actions and potential audits.

4. Notification to the Content Creator: The system automatically sends a notification to the content creator or rights holder. This notification includes detailed information about the violation, such as the type of misuse, when and where it occurred, and which licensed content was involved. The notification may also include recommended actions and options for the content creator to respond.

5. Notification to the User (Violator): Simultaneously, the system sends a notification to the user who violated the terms. This message explains the nature of the violation, which terms were breached, and the potential consequences. It may also provide the user with options to rectify the situation, such as purchasing an appropriate license, removing distributed copies, or disputing the violation if they believe it to be a mistake.

6. Notification to Third-party Network Administrator: If the violation involves a network or platform, a notification is sent to the relevant third-party administrator. This could be the administrator of a company network, a social media platform, or any other involved service. The notification should include sufficient detail for the administrator to understand the violation and its implications, and it may request specific actions, such as removing the infringing content or suspending the user's account.

7. Follow-up Actions: The system tracks the responses from all notified parties. Based on the actions taken by the violator and the content creator, further steps might be necessary. This could include legal action, financial penalties, or the modification of the violator's access rights. The system can facilitate these actions by providing additional documentation and evidence of the violation.

8. Resolution and Documentation: Once the situation is resolved, the system updates the violation record with the outcome and any steps taken by all parties. This documentation is critical for legal purposes and for improving the licensing system.

9. Feedback Loop: Information from resolved violations feeds back into the system to improve future detection and handling of similar incidents. This could involve updating the machine learning model, refining the notification templates, or adjusting the verification process.

10. Communication and Transparency: Throughout the process, maintain transparency and clear communication with all parties involved. This includes providing clear explanations for actions taken and respecting the privacy and rights of all individuals and entities involved.

By following this detailed process, actions taken in response to violations of licensing terms can be thorough, fair, and effective, ensuring that rights holders are protected while also giving alleged violators the opportunity to respond and rectify the situation.

### License Revocation

Revoking a micro-license, including in a blockchain-based system, involves several steps to ensure that the process is transparent, irreversible, and complies with the licensing terms. Here's a detailed process and method for the revocation of a particular micro-license:

### 1. Trigger for Revocation:

a. Determine the conditions under which a license can be revoked. These could include breach of contract, expiration of the license, mutual agreement, or other legal reasons.

b. Detect the violation or trigger condition through automated monitoring, user reports, or manual review.

### 2. Verification and Decision:

a. Verify the breach or condition that triggers the revocation. This might involve reviewing user activity logs, checking smart contract conditions, or assessing evidence of the breach.

b. The licensor or a designated authority decides to proceed with the revocation. This decision could be automated within the smart contract or require manual intervention.

### 3. Notification of Revocation:

a. Notify the licensee of the impending revocation, detailing the reason and the effective date. This ensures transparency and gives the licensee a chance to respond or rectify the breach, if applicable.

b. Notify any relevant third parties, such as network administrators or content platforms, especially if they need to take action as part of the revocation process.

### 4. Update License Status:

a. Update the smart contract associated with the micro-license to reflect the revocation. This could involve changing the status of the license from ‘active’ to ‘revoked’ and recording the reason for revocation.

b. Ensure that the revocation is recorded on the blockchain, providing an immutable audit trail.

### 5. Enforce Revocation:

a. Implement the revocation by disabling the licensee's access to the licensed content. This could involve technical measures like revoking digital keys, removing content from the user's devices, or blocking user access at the content distribution level.

b. Update any content distribution or access systems to reflect the revocation, ensuring that the licensee can no longer use or distribute the content.

### 6. Post-Revocation Actions:

a. Remove or disable any distributed copies of the content that were made under the revoked license, if possible.

b. Monitor for compliance to ensure that the licensee ceases use of the content and does not attempt to bypass the revocation.

### 7. Documentation and Audit:

a. Document the entire revocation process, including the reason for revocation, communications with the licensee, and steps taken to enforce the revocation.

b. Store this documentation securely for legal and audit purposes.

### Push Notifications of Available Licensable Content

1. Subscription Management on Blockchain: Subscriptions are managed via smart contracts on the blockchain. Each subscriber has a profile stored on the blockchain, detailing their subscription preferences, such as topics of interest, frequency of updates, payment details, and other relevant parameters.

2. Content Matching: When new content is added to the platform, another set of smart contracts can automatically match this content against existing subscription preferences. These smart contracts analyze content tags, descriptions, and other metadata to determine which subscribers should receive the content based on their specified interests.

3. Triggering Push Notifications: Once a match is found, the smart contract triggers a push notification. This could be implemented through a few different mechanisms:

a. Off-chain Notification Services: While the matching process occurs on the blockchain, the actual notification can be sent through traditional off-chain services. The smart contract sends a signal to an off-chain server component, which then handles the delivery of push notifications to the relevant users' devices.

b. Notification Services: There are services and protocols that can deliver notifications directly from blockchain transactions or traditional query. These services can listen for specific events on the blockchain (like a subscription match) and send a push notification to the user's device or browser.

4. On-chain Data with Off-chain Alerts: The match and notification instruction are recorded on the blockchain, ensuring transparency and immutability. However, the actual notification is sent via an off-chain system to manage privacy and efficiency, as blockchain itself does not directly support sending push notifications to devices.

5. User Interaction: Upon receiving the push notification, the user can interact with the content directly through the platform's app or website, or API. The user's actions (like viewing, ignoring, or interacting with the content) can also be tracked and used to refine future content matches and notification settings.

6. Privacy and Security: Ensure that user preferences and notification settings are managed securely, respecting user privacy. Blockchain's inherent security features can help with this, but it's crucial to design the off-chain notification component with privacy in mind, particularly if sensitive information is involved.

7. Opt-In and Customization: Users should be able to opt-in for push notifications and customize their settings, such as frequency, types of notifications, and channels through which they want to receive them. This can enhance user satisfaction and engagement.

This approach combines the immutable and transparent record-keeping capabilities of blockchain with the immediate and user-friendly nature of push notifications. It allows subscribers to stay informed about relevant content matches without compromising the benefits of the blockchain model.

### Implicit License Acceptance

The Implicit License Acceptance mechanism, as integrated into the digital content download process, introduces an innovative and streamlined approach to establishing agreements between content creators, publishers, and consumers regarding the use of digital media. This mechanism is designed to simplify the user experience significantly while upholding the integrity and legality of content consumption. At the core of this process is the intuitive action of downloading digital content, which, within this system, doubles as a user's agreement to the content's predefined licensing terms.

When a user selects a piece of digital content for download, they are not just initiating a transfer of data. Instead, they are engaging in a clear and informed act that, according to the system's design, constitutes an acceptance of the licensing terms associated with that content. These terms are meticulously embedded within the immutable blockchain record, and where applicable the Non-Fungible Token (NFT) metadata that represents the digital content, ensuring that all pertinent information regarding content use is transparently communicated to the user prior to the download. This pre-download transparency is crucial, as it ensures that the user's agreement to the terms is both informed and deliberate.

The moment the user proceeds with the download, a smart contract associated with the content's NFT is activated. This smart contract is a piece of self-executing code that lives on the blockchain and is responsible for recording the transaction and the user's implicit acceptance of the licensing terms. The execution of this smart contract creates an immutable ledger entry on the blockchain, which serves as an unalterable record of the agreement between the user and the content provider. This blockchain-based recording method not only enhances the security of the transaction but also provides a transparent and verifiable account of the agreement, accessible to all parties involved.

The simplicity of this process eliminates the need for users to navigate through cumbersome and often convoluted steps typically associated with digital content licensing agreements. By reducing the process to a single, meaningful action—downloading—the system not only streamlines access to digital content but also respects the user's time and experience. Furthermore, the transparency and security afforded by the blockchain ensure that users are making informed decisions under clearly defined terms, fostering a greater sense of trust in digital content transactions.

Moreover, the adaptability of this system allows for the customization of licensing terms by content creators and publishers, who can tailor these terms to suit different types of content, target demographics, or specific use cases. This flexibility ensures that the Implicit License Acceptance mechanism can accommodate a wide range of content and user preferences, further enhancing the system's utility and appeal.

In essence, the Implicit License Acceptance mechanism signifies a paradigm shift in how digital content licensing agreements are conceptualized and implemented. By leveraging the inherent functionalities of blockchain technology and smart contracts, this mechanism offers a solution that is not only efficient and user-friendly but also secure, transparent, and legally binding. It represents a significant advancement in the digital rights management landscape, promising a future where accessing digital content is as straightforward as it is trustworthy.

### Machine Learning Detection of Misuse of Licensed Content

A machine learning algorithm designed to detect misuse of licensed digital content typically involves several steps and components. Here is a detailed description of how such an algorithm could work in embodiments of this invention:

1. Data Collection: First, the algorithm requires a dataset of user behaviors and content interactions. This includes legitimate uses of content under license terms and instances of misuse or violation, such as unauthorized sharing or access beyond the agreed terms. Data could also include timestamped logs of access, user interaction patterns with the content, and digital fingerprint detections.

2. Feature Extraction: From this data, the algorithm extracts relevant features that help differentiate between proper use and misuse. Features might include frequency of access, types of interactions (e.g., view, download, share), access locations, time spent with the content, and the presence of digital fingerprints in unauthorized locations.

3. Model Training: Using the collected data and extracted features, the algorithm is trained to identify patterns of misuse. Common machine learning models for this purpose could include decision trees, support vector machines (SVM), or neural networks. The choice of model depends on the complexity of the task and the nature of the data. The training process involves adjusting the parameters of the model to minimize the error between its predictions and the actual data labels (legitimate use vs. misuse).

4. Validation and Testing: After training, the model is validated and tested using a separate set of data not seen by the model during training. This step is crucial to evaluate the model's accuracy and its ability to generalize to new, unseen examples. Performance metrics such as precision, recall, and F1 score are used to assess the effectiveness of the model in detecting misuse.

5. Deployment: Once validated, the model is deployed within the content management system. As part of the system, it continuously analyzes user behavior and content interaction patterns. When the model identifies a likely misuse based on the learned patterns, it triggers an alert for further investigation or automatic enforcement actions, depending on the system's design.

6. Continuous Learning: Over time, the algorithm can be updated with new data reflecting evolving usage patterns and emerging forms of misuse. This process, known as retraining or fine-tuning, helps the model stay effective even as conditions change.

7. Transparency and Feedback Loop: To ensure fairness and reduce false positives, the system should include a feedback mechanism where users can contest misuse allegations. Feedback from these cases can be used to further refine and train the model, improving its accuracy.

Example Algorithm-Decision Tree: As an example, a decision tree algorithm could be used for misuse detection. The tree's branches represent the features extracted from the data (e.g., number of times content was accessed), and the leaves represent the outcomes (legitimate use or misuse). The algorithm splits the data at each node based on feature values that most effectively separate misuse from legitimate use, creating a tree structure that can classify new instances based on their features.

Note: Implementing such an algorithm involves careful consideration of privacy and ethical standards, particularly when handling user data. It is important to comply with all relevant regulations and standards, such as GDPR for users in the European Union.

This machine learning approach provides a dynamic and adaptive method for detecting misuse of licensed digital content, allowing for more effective and timely enforcement of licensing terms.

### System-Based Violation Resolution

Certain embodiments of this invention use a process and method for taking action when violations of licensing terms occur, involving notifications to the content creator, the user who violated the terms, and a third-party network administrator:

1. Violation Detection: The system, utilizing the described machine learning algorithm, identifies a potential violation of the licensing terms. This could be unauthorized distribution, excessive access, or other forms of misuse as defined by the licensing agreement.

2. Initial Verification: Before any notifications are sent, the system performs an initial verification to confirm the violation. This step reduces false positives and ensures that the detected activity genuinely contravenes the licensing terms. The verification process may analyze additional data or apply more stringent criteria to confirm the misuse.

3. Record and Log: Once a violation is confirmed, the system logs the details, including the nature of the violation, the identity of the user, time stamps, and any other relevant information. This record will be essential for further actions and potential audits.

4. Notification to the Content Creator: The system automatically sends a notification to the content creator or rights holder. This notification includes detailed information about the violation, such as the type of misuse, when and where it occurred, and which licensed content was involved. The notification may also include recommended actions and options for the content creator to respond.

5. Notification to the User (Violator): Simultaneously, the system sends a notification to the user who violated the terms. This message explains the nature of the violation, which terms were breached, and the potential consequences. It may also provide the user with options to rectify the situation, such as purchasing an appropriate license, removing distributed copies, or disputing the violation if they believe it to be a mistake.

6. Notification to Third-party Network Administrator: If the violation involves a network or platform, a notification is sent to the relevant third-party administrator. This could be the administrator of a company network, a social media platform, or any other involved service. The notification should include sufficient detail for the administrator to understand the violation and its implications, and it may request specific actions, such as removing the infringing content or suspending the user's account.

7. Follow-up Actions: The system tracks the responses from all notified parties. Based on the actions taken by the violator and the content creator, further steps might be necessary. This could include legal action, financial penalties, or the modification of the violator's access rights. The system can facilitate these actions by providing additional documentation and evidence of the violation.

8. Resolution and Documentation: Once the situation is resolved, the system updates the violation record with the outcome and any steps taken by all parties. This documentation is critical for legal purposes and for improving the licensing system.

9. Feedback Loop: Information from resolved violations feeds back into the system to improve future detection and handling of similar incidents. This could involve updating the machine learning model, refining the notification templates, or adjusting the verification process.

10. Communication and Transparency: Throughout the process, maintain transparency and clear communication with all parties involved. This includes providing clear explanations for actions taken and respecting the privacy and rights of all individuals and entities involved.

### Smart Contracts for Licensable Artifacts

In these preferred embodiments using micro-licensing, smart contracts play a central role in creating, managing, and enforcing licenses for digital content, including documents and their revisions. These smart contracts are deployed on a blockchain platform, ensuring transparency, security, and immutability.

1. Creation and Issuance of Licenses: When a new piece of content is created and ready for distribution, a corresponding smart contract reference is deployed to the blockchain. This smart contract contains the terms of the license, such as the allowed uses of the content, the duration of the license, and the price. When a user wishes to access the content and agrees to these terms, the smart contract automatically processes the transaction: it verifies the payment, issues the license, and records the transaction on the blockchain. This ensures that the issuance of licenses is immediate, transparent, and error-free.

2. Real-time Licensing and Subscription Matching: Smart contracts facilitate real-time licensing by constantly monitoring for matches between available content and user subscriptions. When a piece of content matches a user's subscription criteria (such as topic, length, or format), the smart contract automatically initiates the licensing process. If the content is updated or revised, the smart contract also assesses whether the updated version still fits the criteria of existing subscriptions and, if so, automatically updates the licenses to cover the new version, ensuring continuous access for the user.

3. Automated Adjustments and Renewals: As content evolves, its licensing needs may change. Smart contracts can be programmed to handle these changes dynamically. For example, if a document is updated with new chapters or revised information, the smart contract can automatically notify existing license holders of the update and, based on the user's subscription model, either grant access to the new content, prompt the user to extend their license, or adjust the license terms accordingly.

4. Audit Trails and Transparency: Every transaction and interaction with the smart contract is recorded on the blockchain, creating an immutable audit trail. This includes the initial licensing transactions, any adjustments made to the license (such as extensions or updates due to revised content), and access logs. This transparency ensures that all parties can verify the history and terms of the license at any time, fostering trust and compliance.

5. Enforcement of Licensing Terms: Smart contracts enforce the terms of the licenses automatically. For instance, if a license restricts the use of the content to a certain number of views or a specific time period, the smart contract monitors this usage and ensures compliance. If the terms are violated, the smart contract can automatically revoke access, enforce penalties, or notify the content creator.

6. Handling of Payments and Royalties: The smart contracts also manage the financial transactions associated with licensing. They ensure that payments made by users are securely transferred to the content creators. Additionally, if the content generates royalties (for example, every time it is viewed or cited), the smart contract automatically calculates and distributes these royalties according to the predetermined terms.

By leveraging smart contracts in these ways, the micro-licensing system ensures that the process of licensing digital content, including managing revisions and updates, is automated, secure, and transparent. This automation reduces administrative overhead, minimizes errors, and provides a clear, auditable trail of all transactions and interactions with the licensed content.

### Endorsements and Endorsements Marketplace

Enhanced embodiments combine a content endorsement marketplace with the current micro-licensing platform that uses blockchain technology. Content creators can offer their content to the marketplace, looking for endorsements from experts or organizations in related fields. These experts can evaluate submissions, give endorsements, or improve the content, thus raising its trustworthiness and possible value. Endorsed content is then accessible on the platform, with its updated status emphasized, affecting licensing conditions, exposure, and user confidence.

### 1. Marketplace for Endorsements:

a. Create a dedicated marketplace within the platform where content creators can list content for endorsement. This marketplace allows authoritative sources to browse, review, and choose content they wish to endorse or augment.

b. Include features for categorizing content by topic, popularity, and endorsement needs, making it easier for authorities to find relevant content to endorse.

### 2. Authority Profiles and Verification:

a. Develop profiles for authoritative sources, detailing their credentials, areas of expertise, and endorsement history. Implement a verification process to confirm the legitimacy and expertise of these sources.

b. Allow content creators to view and select authoritative sources based on their preferences and the relevance to their content.

### 3. Endorsement Process and Smart Contracts:

a. Utilize smart contracts to manage the endorsement process, recording terms, agreements, and any compensation details. These contracts ensure transparency and enforce the terms agreed upon by the content creators and the endorsing authorities.

b. Implement a system for authoritative sources to provide feedback, suggestions, or content augmentation directly through the platform, which is then attached to the original content along with the endorsement.

### 4. Licensing and Visibility Enhancements:

a. Adjust the content's licensing terms based on endorsements, potentially increasing its value and altering its pricing or access conditions.

b. Enhance the visibility of endorsed content within the platform, highlighting its authoritative backing to attract more users and licensees.

### 5. Revenue Sharing and Incentives:

a. Establish a revenue-sharing model for endorsed content, where a portion of licensing fees is allocated to the endorsing authority, incentivizing them to provide thoughtful and meaningful endorsements.

b. Create incentives for content creators to seek endorsements, such as increased platform visibility, higher licensing fees, or enhanced credibility.

### 6. Feedback and Ratings System:

a. Implement a feedback system allowing content creators and platform users to rate and review authoritative sources, fostering accountability and quality in the endorsement process.

b. Provide feedback mechanisms for authoritative sources to evaluate the content and its creators, contributing to a cycle of improvement and credibility building.

### 7. Endorsement History and Tracking:

a. Track and display the history of endorsements for each piece of content and authority, creating a transparent record of interactions and augmentations.

b. Use blockchain technology to ensure that all endorsement transactions and changes to content are securely recorded and immutable.

8. Integration with Existing Systems:

a. Seamlessly integrate the endorsement marketplace with the existing micro-licensing and content distribution systems, ensuring a unified user experience.

b. Ensure that the process of seeking, obtaining, and showcasing endorsements is streamlined and user-friendly, complementing the existing functionalities of the platform.

By expanding the system to include a marketplace for content endorsements, the platform can provide additional value to content creators and users, leveraging the credibility and expertise of authoritative sources to enhance content trustworthiness and marketability. Additionally, this provides a new revenue stream to endorsers, and improves the value of otherwise somewhat baseless claims in artifacts.

### Endorsement Acquisition and Validation: Trusted Endorsement Integration Model

### 1. Endorsement Acquisition and Tokenization:

a. Advertisers seek endorsements from recognized authorities, experts, or reputable entities within relevant fields to validate the claims made in their advertisements.

b. Upon obtaining such endorsements, the information, including the endorser's identity, credentials, and the specific claims endorsed, is tokenized as part of the advertisement's Non-Fungible Token (NFT). This tokenization process securely embeds the endorsement within the blockchain, creating an immutable association between the ad and its endorsement.

### 2. Smart Contract for Endorsement Validation:

a. A smart contract is deployed for each endorsed advertisement, programmed with logic to verify the authenticity of the endorsement based on the endorser's credentials and the relevance of the endorsement to the advertisement's claims.

b. The smart contract also includes mechanisms for periodic re-validation of the endorsement, ensuring that the advertisement remains compliant with any evolving standards or regulations pertinent to the endorsed claims.

3. Advertisement Exposure through Certified Channels:

a. Endorsed advertisements are distributed via certified channels within the platform's ecosystem, ensuring that only ads with verified and current endorsements are exposed to consumers.

b. Publishers and content platforms integrate with the system's API to access the repository of endorsed advertisements, selecting ads for publication based on their certification status and alignment with platform values and consumer expectations.

### Method for Trusted Advertisement Exposure

1. Consumer Interaction with Endorsed Ads:

Consumers, equipped with a browser plugin or application interface that interacts with the system, can view the details of endorsements directly within the advertisement exposure. This includes accessing the blockchain to verify the endorsement's authenticity and current validity.

### 2. Dynamic Feedback and Rating System:

The system incorporates a dynamic feedback mechanism allowing consumers to rate their trust in the advertisement based on the provided endorsement. This feedback contributes to an aggregated trust score for each advertisement, further guiding advertisers and publishers in refining ad content and endorsements.

### 3. Economic Incentives for Endorsed Advertisement Placement:

Advertisers compensate publishers for the placement of endorsed ads through a reversed payment model facilitated by smart contracts. This model incentivizes the promotion of high-quality, trustworthy advertisements, aligning economic rewards with the integrity of ad content.

### 4. Automated Compliance and Monitoring:

Continuous monitoring of endorsed advertisements is conducted via AI algorithms to detect any discrepancies or changes in the endorsement status. Smart contracts automatically adjust the advertisement's exposure based on compliance, ensuring that only ads with valid and relevant endorsements reach consumers.

### Reverse Payment and Subscription Model

The innovative aspect of the system outlined in this patent application fundamentally shifts the traditional dynamics of online advertising by introducing a reversed subscription and payment model. In this model, advertisers subscribe to publishers' channels, and it is the advertisers who compensate the publishers for the opportunity to place their ads. This reversal redefines the conventional advertiser-publisher relationship and establishes a novel concept of a “license to advertise,” granted by the publisher to the advertiser. Below, we detail the operational mechanisms of this model, emphasizing the role of trusted endorsements in shaping these interactions.

### Reversed Subscription and Payment Model

### 1. Advertiser Subscription to Publisher Channels:

In this model, advertisers actively seek out publishers whose channels align with their target demographics and values. Advertisers subscribe to these channels, signaling their interest in placing their advertisements within the publisher's content ecosystem.

### 2. License to Advertise:

Publishers grant advertisers a “license to advertise,” which is effectively permission to display their ads on the publisher's platform. This license is contingent on several criteria, including the adherence of the advertisement to the publisher's content standards and the presence of verified endorsements from trusted agencies or organizations.

### 3. Payment Reversal:

Contrary to the traditional model where publishers might charge a flat rate or a performance-based fee for ad placement, this system sees advertisers compensating publishers for the privilege of accessing their curated audience. Payments are facilitated through smart contracts, ensuring transparency and adherence to agreed terms.

### 4. Endorsement Filters for Ad Acceptance:

Publishers set filters based on endorsements from trusted agencies, firms, or participating organizations. These filters serve as criteria for ad acceptance, ensuring that only advertisements verified by credible entities are eligible for placement. This mechanism supports publishers in maintaining content integrity and alignment with audience expectations.

### 5. Verifiable Endorsements by Publishers and Consumers:

Both publishers and consumers can verify the endorsements associated with any given advertisement. This verification process is supported by the blockchain infrastructure, which provides an immutable record of endorsements, enhancing trust in the advertised content.

### Operational Mechanisms

### 1. Smart Contract Implementation:

Smart contracts automate the subscription, payment, and ad placement processes. Upon an advertiser's subscription to a publisher's channel, a smart contract is initiated, detailing the terms of the license to advertise, including payment conditions and endorsement requirements.

### 2. Dynamic Subscription Management:

Publishers can dynamically manage subscriptions, adjusting their criteria for ad acceptance as market conditions or audience preferences evolve. Advertisers, in turn, can update their endorsements and ad content to meet these changing criteria, ensuring continued access to valuable advertising channels.

### 3. Automated Compliance Monitoring:

The system employs AI algorithms to continuously monitor advertisements for compliance with the license to advertise terms. This includes verifying the current validity of endorsements and the alignment of ad content with publisher filters.

### 4. Transparent Transaction Ledger:

All transactions, including subscription payments and the granting of advertising licenses, are recorded on the blockchain. This ledger provides a transparent and auditable history of the financial interactions between advertisers and publishers, as well as the compliance status of advertisements.

This reversed subscription and payment model, underpinned by the concept of a license to advertise and the critical role of trusted endorsements, represents a significant innovation in digital advertising. By shifting the economic and operational dynamics between advertisers and publishers, the system not only fosters a higher standard of advertising content but also enhances the overall trustworthiness of online advertising ecosystems. Publishers gain greater control over the content presented to their audiences, while advertisers access engaged and relevant viewers through verifiably credible ads. This model, supported by blockchain technology, smart contracts, and AI, provides a robust infrastructure for the future of digital advertising, where integrity, transparency, and consumer trust are paramount.

### IMPLEMENTATION EXAMPLE

This example provides an implementation whereby an advertiser contacts endorsers that verify the suitability of ad for age/maturity, accuracy and truth in advertising. The endorser then uses the system that enters findings in the blockchain (upon approval of the advertiser), where it is facilitated by the system. Publishers then, using the system marketplace, find advertising content they consider appropriate in topic, maturity and compensation, license the advertiser to utilize the publisher's digital platform to present their content. The content also declares the endorser's findings in a way that verifiable to the consumer.

### ChatGPT

Implementing a system where advertisers, endorsers, and publishers interact to ensure the accuracy, age-appropriateness, and truthfulness of advertising content involves a structured approach leveraging blockchain technology. This system not only ensures the integrity of online advertisements but also facilitates a marketplace where publishers can confidently select and host content that aligns with their standards and audience expectations. Below is an outline of the implementation process, highlighting the key stages and interactions between advertisers, endorsers, publishers, and consumers.

### Stage 1: Advertiser and Endorser Collaboration

### 1. Initial Contact:

Advertisers create their advertising content and identify reputable endorsers who can verify the content's suitability for specific age/maturity levels, accuracy, and adherence to truth in advertising principles.

### 2. Verification by Endorsers:

Endorsers review the advertisement against established criteria for truthfulness, accuracy, and age-appropriateness. This review process may involve checking claims against factual databases, assessing the content's maturity level, and ensuring compliance with advertising standards.

### 3. Blockchain Recording:

Upon approval by the advertiser, endorsers record their findings and endorsements on the blockchain. This action creates an immutable record of the endorsement, linked directly to the specific advertisement.

### Stage 2: Marketplace Interaction and Publisher Licensing

### 1. System Marketplace:

Publishers access the syste's marketplace, a digital platform where verified advertisements are listed. Each listing includes detailed information about the ad, including its topic, maturity level, compensation offered by the advertiser, and the endorsers' findings.

### 2. Publisher Selection:

Using the marketplace, publishers filter and select advertisements that match their content criteria, audience maturity, and compensation requirements. The selection process is facilitated by the blockchain, ensuring that all available information about advertisements and endorsements is accurate and up-to-date.

### 3. License Granting:

Once a publisher selects an advertisement, they grant the advertiser a license to utilize the publisher's digital platform for presenting the content. This licensing agreement is recorded on the blockchain, establishing a transparent and enforceable contract between the advertiser and publisher.

### Stage 3: Consumer Verification and Engagement

### 1. Consumer Interaction:

When consumers encounter the advertisement on the publisher's platform, they have the ability to verify the endorsers' findings. This could be facilitated through a user interface element (e.g., a tooltip or hyperlink) that, when interacted with, displays the endorsement details directly from the blockchain.

### 2. Transparency and Trust:

This direct link to verifiable endorsement information empowers consumers to make informed decisions about the advertisements they see, enhancing trust in both the content and the platform hosting it.

### IMPLEMENTATION CONSIDERATIONS

Blockchain Infrastructure: The foundation of this system is a robust blockchain infrastructure that supports smart contracts for recording endorsements, licensing agreements, and transactions in a transparent, immutable manner.

AI and Machine Learning: AI algorithms could be employed to assist endorsers in the verification process, analyzing advertisement content for factual accuracy and flagging potential issues for human review.

Marketplace Design: The system marketplace needs to be intuitively designed, allowing publishers to easily filter and select advertisements based on detailed criteria, including endorsements, compensation, and content maturity.

Consumer Verification Interface: A user-friendly interface is essential for allowing consumers to access and understand endorsement information. This interface should seamlessly integrate with the publisher's digital platform, providing a non-intrusive yet informative experience.

This implementation framework outlines a comprehensive approach to ensuring the integrity of online advertising content, leveraging the power of blockchain technology to facilitate interactions between advertisers, endorsers, publishers, and consumers. By establishing a system that emphasizes verification, transparency, and accountability, this model significantly enhances trust in digital advertising, benefiting all stakeholders involved.

### Provided Consumer Awareness and Control

In the context of the patent application detailing an innovative approach to digital content verification and distribution, a significant component is the implementation of browser plugins or capabilities designed to empower consumers with unprecedented control over their digital content consumption. This detailed description explicates the functionality of such browser plugins, focusing on enabling consumers to interact with content based on its trustworthiness, as determined by trusted endorsements and other verifiable metrics.

### Overview of Browser Plugin Capabilities

The browser plugin acts as an intermediary between the consumer and digital content across the internet, interfacing with the blockchain-based system to access real-time data on content endorsements, trust levels, and accuracy scores. By leveraging the system's comprehensive verification framework, the plugin provides consumers with the tools to customize their content consumption experience according to personal or community-established standards of trustworthiness.

### Consumer Control and Customization

### 1. Content Endorser Selection:

Consumers can specify which entities or organizations they trust to endorse content. This selection process is facilitated by the plugin's interface, which lists verified endorsers registered on the blockchain. Consumers can choose one or multiple endorsers based on their credibility and relevance to the consumer's interests.

### 2. Content Type and Maturity Filtering:

The plugin allows consumers to set preferences for the types of content they wish to view, such as news, educational material, or entertainment, and to specify content maturity levels appropriate for their consumption or that of their household. This granularity ensures that content not meeting these criteria is automatically filtered out of the consumer's browsing experience.

### 3. Trust Level and Accuracy Score Thresholds:

Consumers can define minimum trust levels and accuracy scores for the content they are willing to engage with. These thresholds are based on the evaluations assigned by selected endorsers, ensuring that only content deemed reliable and accurate according to the consumer's standards is displayed.

### Enhanced Browsing Experience

### 1. Selective Content Blocking:

Based on the consumer's predefined settings, the browser plugin can block entire publishing sites known for not participating in the trusted network or for consistently failing to meet the trust and accuracy criteria. This feature significantly enhances the quality of the consumer's digital environment by minimizing exposure to unverified or potentially misleading content.

### 2. Bypass Option for Selected Sites:

Consumers have the flexibility to whitelist certain publishing sites, allowing them to bypass the standard content filtering. For content from these sites that does not meet the established trust criteria, the plugin can display a warning alongside the content. This warning informs the consumer of the specific reason for the caution, such as low trust levels, potential spam content, or other factors contributing to its unverified status.

### 3. Interactivity and Feedback:

The plugin not only filters and blocks content based on consumer settings but also enables consumers to interact with content warnings, learn more about the reasons behind content filtering, and an ability to provide feedback on the accuracy of content endorsements. This feedback loop contributes to the continuous improvement of the content verification system, including events that are available to network participants. This allows Endorsers to improve their process, value and relevance.

### Framework for Network Events Integration

### 1. Event Generation Mechanism:

System Events: Automatically generated by the system in response to specific actions, such as the addition, modification, or removal of content on the network. Actions performed on the system itself, like updates to the blockchain or changes in smart contract parameters, also trigger system events.

License Events: These events are related to the lifecycle of licenses managed within the system. Events include the issuance of a new license, acceptance of license terms by a user, revocation of a license, and detection of license violations. These events ensure transparency and facilitate compliance monitoring.

Market Events: Generated in response to market dynamics or analytics derived from within the system. Examples include changes in content popularity, new trends in content consumption, or external factors affecting the market. These events help users stay informed about market conditions and potential opportunities.

### 2. Event Payloads:

Each event carries a payload with detailed information about the occurrence. This may include the type of event, timestamp, entities involved (e.g., content ID, user ID, license ID), and a description of the action taken or the change observed. For market events, the payload might also contain analytical data or insights.

### 3. Event Subscription Model:

Users, content creators, and other stakeholders can subscribe to receive notifications about specific types of events. This subscription model should be flexible, allowing subscribers to choose which events they are interested in based on categories, keywords, or specific criteria related to their interests or roles within the system.

Implementing a publish/subscribe (pub/sub) messaging pattern can facilitate this functionality, where the system publishes events, and subscribers receive notifications based on their subscription preferences.

### 4. Real-Time Notification System:

Integrate a real-time notification system to alert subscribers of events as they occur. Notifications can be delivered through various channels, such as email, SMS, mobile push notifications, or webhooks, depending on the subscriber's preferences.

Consider using decentralized services or protocols for notification delivery to align with the blockchain-based architecture of the system.

### 5. Security and Privacy Considerations:

Ensure that event generation, subscription, and notification mechanisms adhere to security and privacy standards. Sensitive information within event payloads should be encrypted or anonymized as necessary.

Implement access controls to ensure that subscribers only receive notifications for events they are authorized to view, especially for events related to license agreements or market analytics.

### 6. Analytical and Reporting Tools:

Provide tools for analyzing event data, enabling stakeholders to gain insights into system activity, license compliance, and market trends. This can support strategic decision-making and operational improvements.

Offer reporting features that allow users to generate summaries or detailed reports based on historical event data.

### Exemplary Process Flow of Certain Tasks/Tools

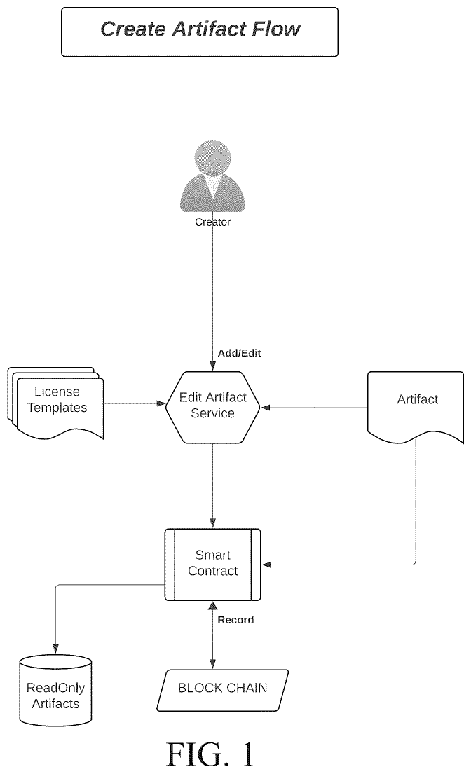

FIG. 1 shows an embodiment of a process flow for the digital content of the creator adding/editing a digital artifact, choosing a license template, generating a smart contract and recording in the blockchain.

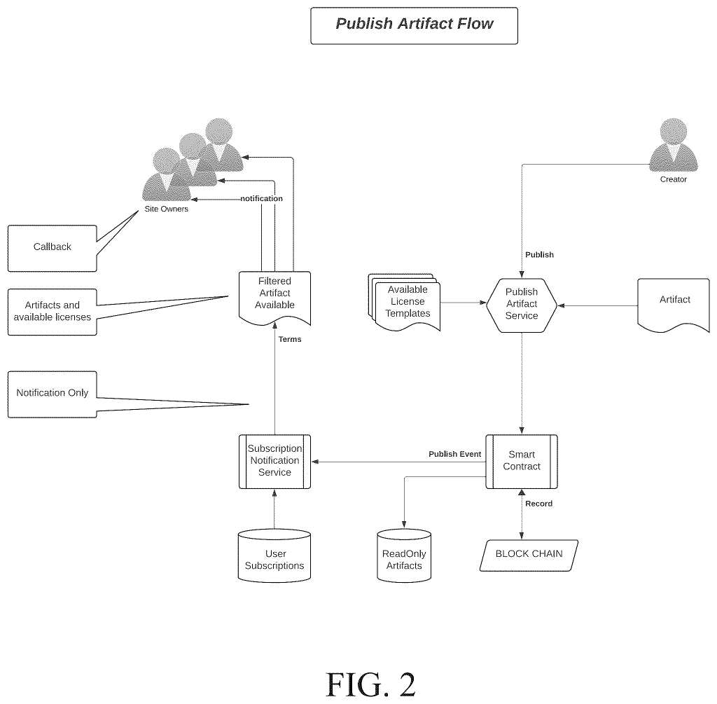

FIG. 2 shows an embodiment of a process flow for publishing the digital artifact of FIG. 1 and relating it to a subscription service and site owners.

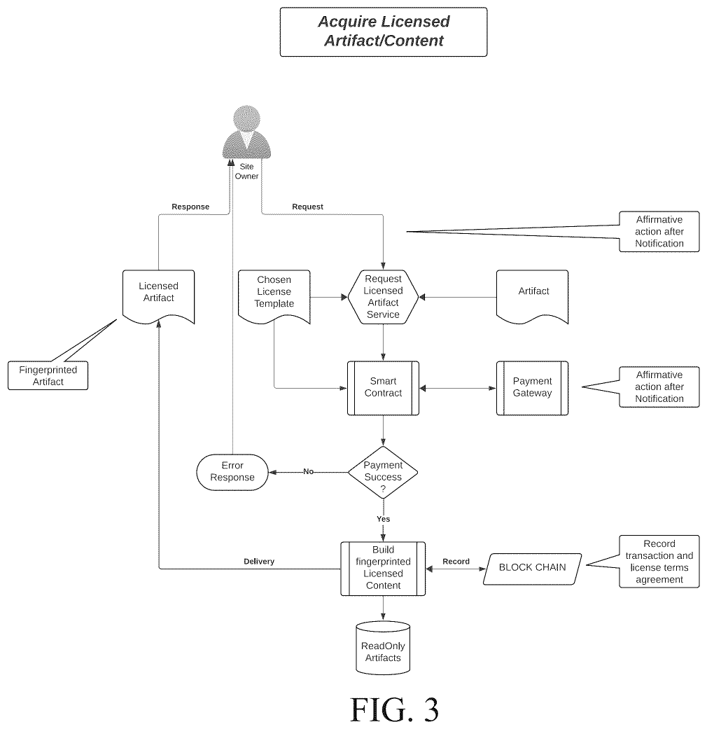

FIG. 3 shows an embodiment of a process flow for acquiring licensed digital artifact/content starting with a request, and proceeding with a smart contract action, payment, interaction with blockchain that records the transaction and license terms, and response.

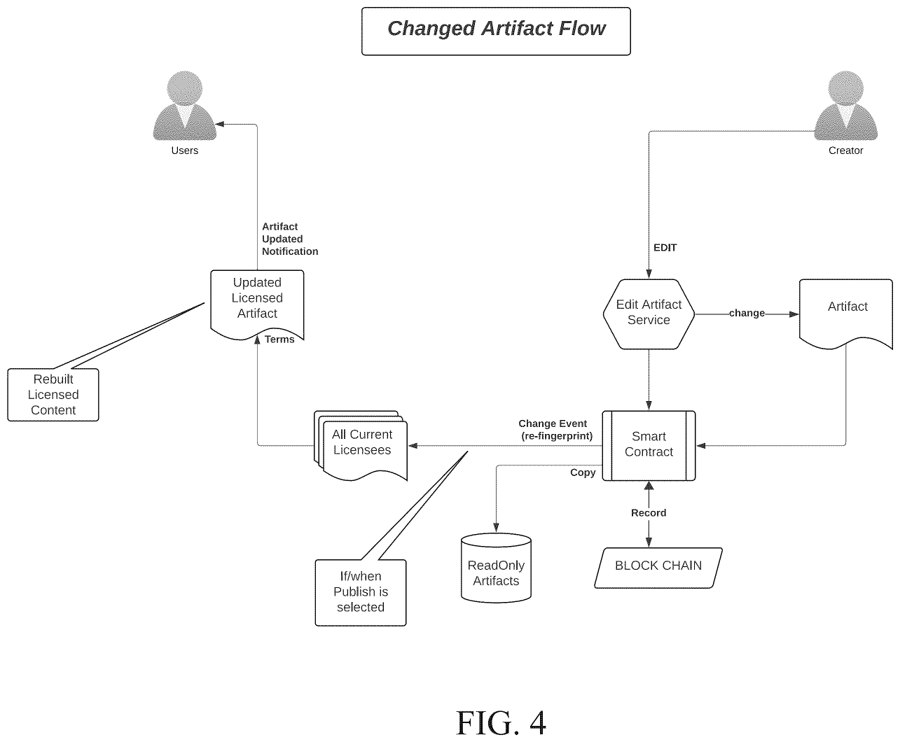

FIG. 4 shows an embodiment of a process flow for a changed digital artifact starting with an edit, and proceeding with a smart contract action, blockchain record, change event (re-fingerprinting) and the updated licensed artifact notification to users.

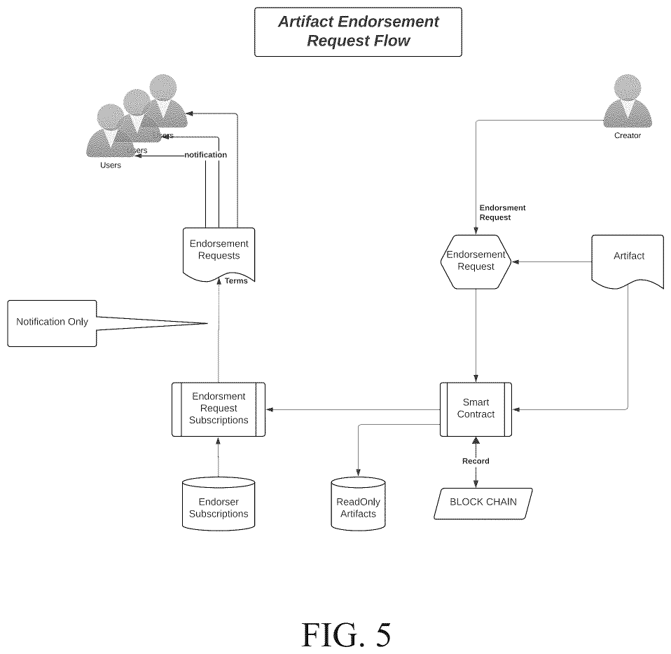

FIG. 5 shows an embodiment of a process flow for a digital artifact endorsement request starting with an endorsement request, and proceeding with a smart contract action, blockchain record, and endorsement request notification with terms to users.

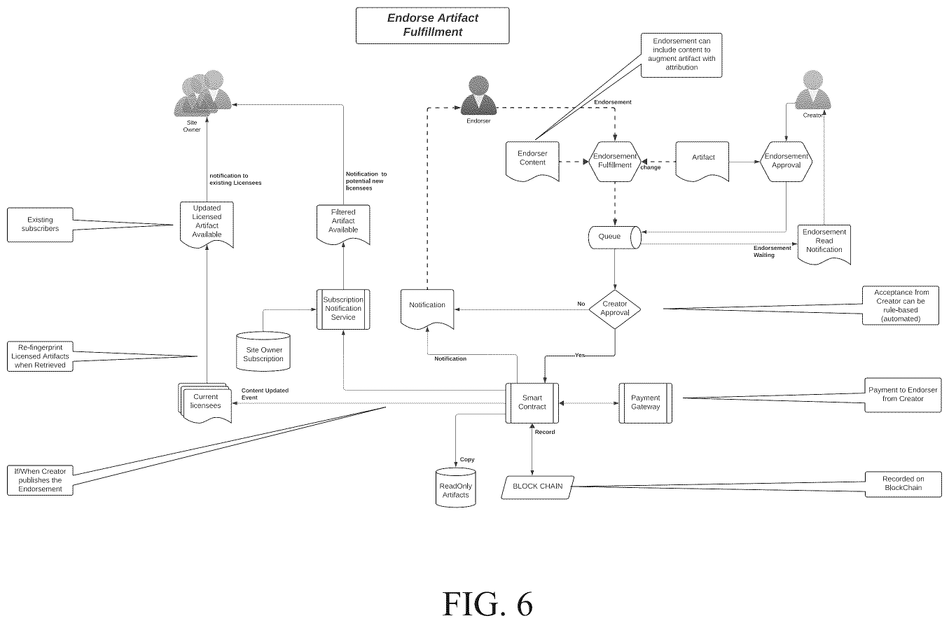

FIG. 6 shows an embodiment of a process flow for an endorsed artifact fulfillment starting with endorsement approval, and then endorsement fulfillment, creator approval, smart contract action, blockchain record, payments and notifications, and updating of the licensed artifact.

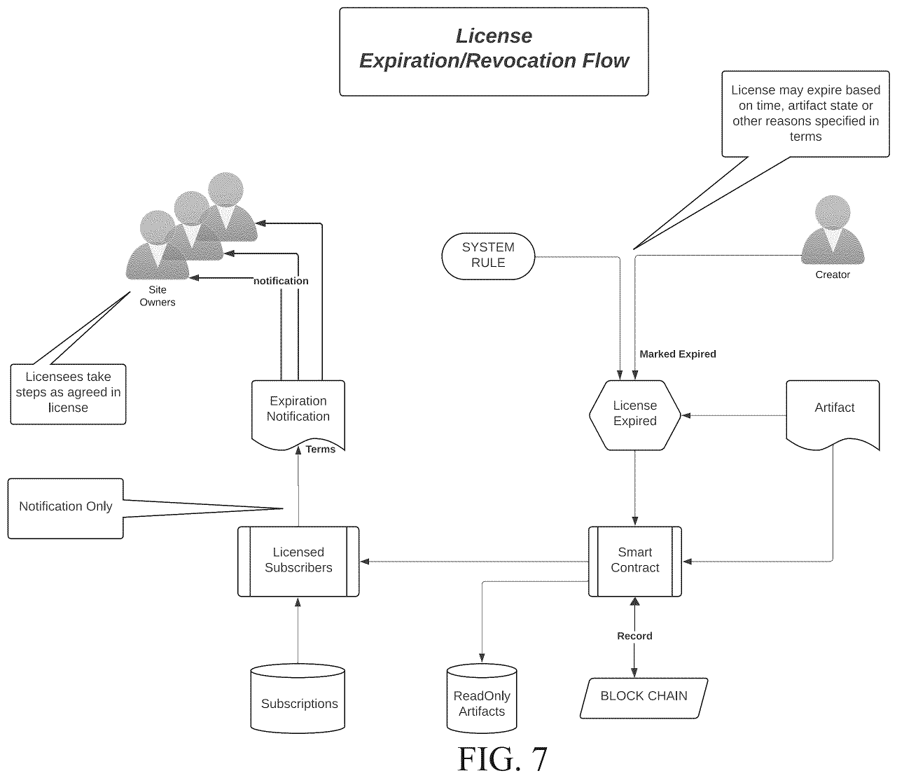

FIG. 7 shows an embodiment of a process flow for a license expiration/revocation starting with a license expiration, and proceeding with a smart contract action, blockchain record, and notification to licensed subscribers.

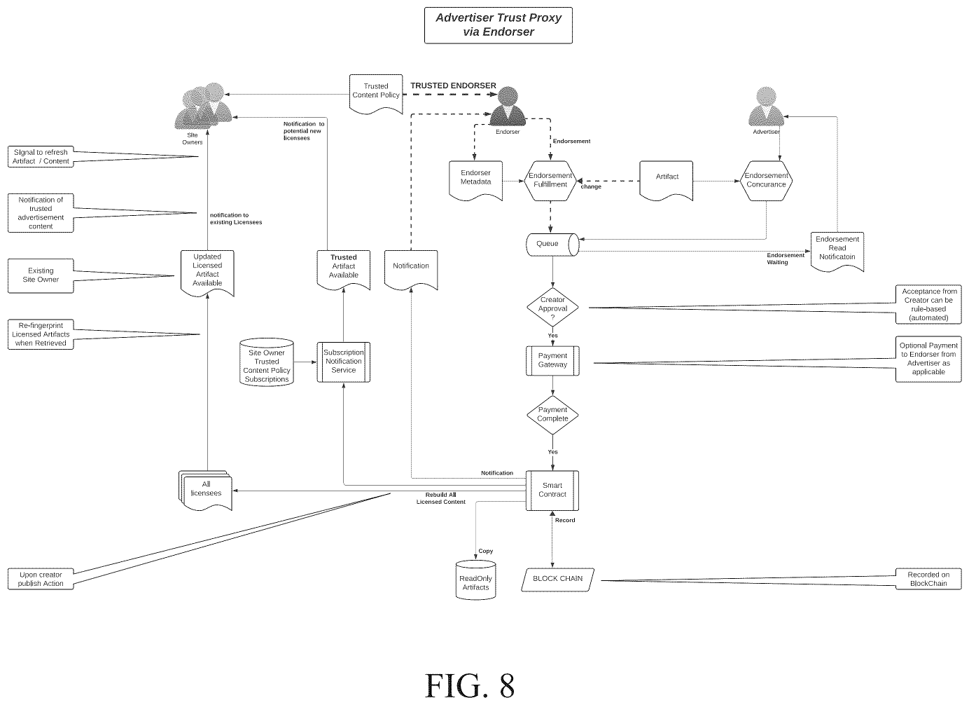

FIG. 8 shows an embodiment of a process flow for obtaining an advertiser trust proxy via an endorser, in an advertisement application of the invention. Starting with an advertiser obtaining an endorsement, creator approval, payment, smart contract action, blockchain record, notifications and updated license artifacts.

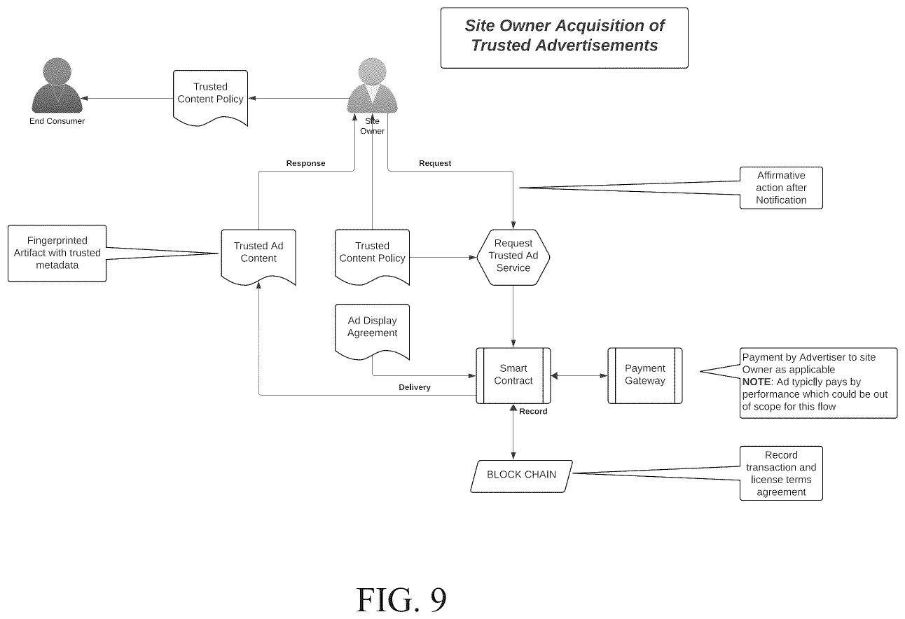

FIG. 9 shows an embodiment of a process flow for an acquisition of trusted advertisements, in an advertisement application of the invention. Starting with a request for trusted ad service, smart contract action, blockchain record, and providing trusted ad content.

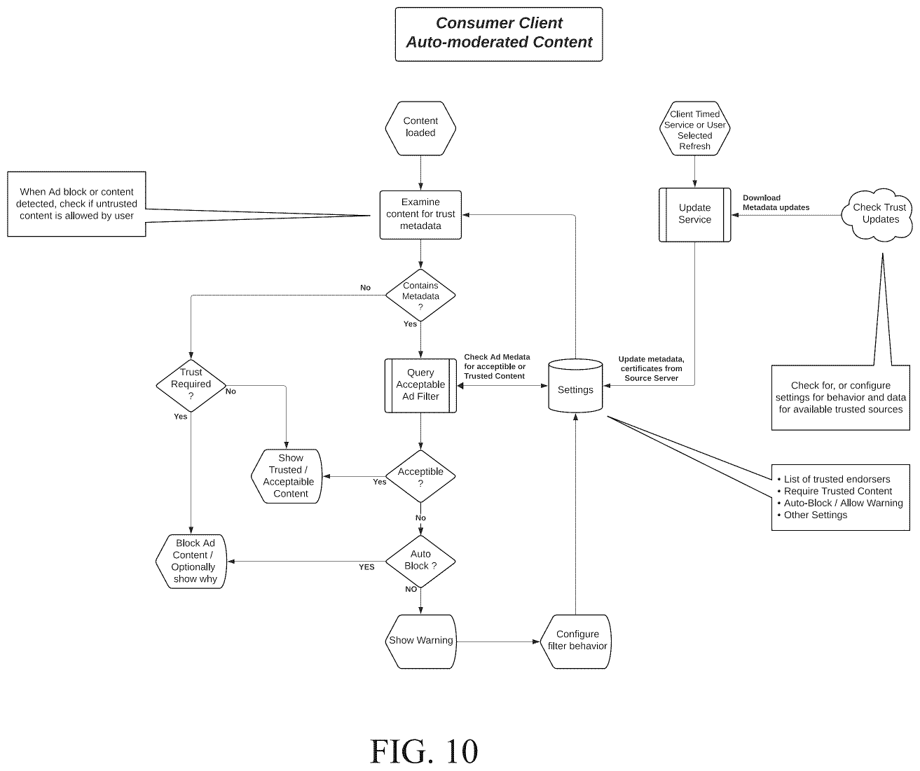

FIG. 10 shows an embodiment of a process flow for consumer client auto-moderated digital content in an advertisement application of the invention, wherein the content is loaded, examined for trust metadata, and then the settings are updated with the results.

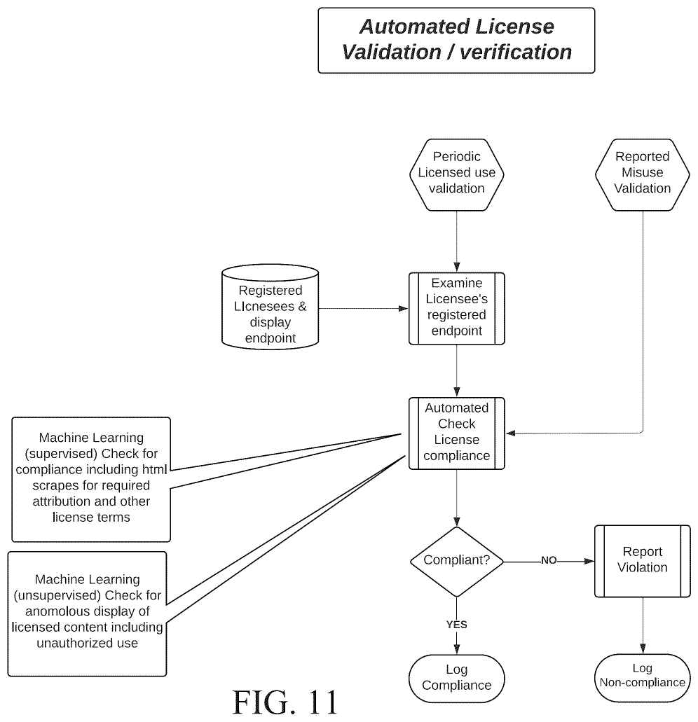

FIG. 11 shows an embodiment of a process flow for an automated license validation/verification process with automated checking by supervised and unsupervised machine learning, and reporting of such.

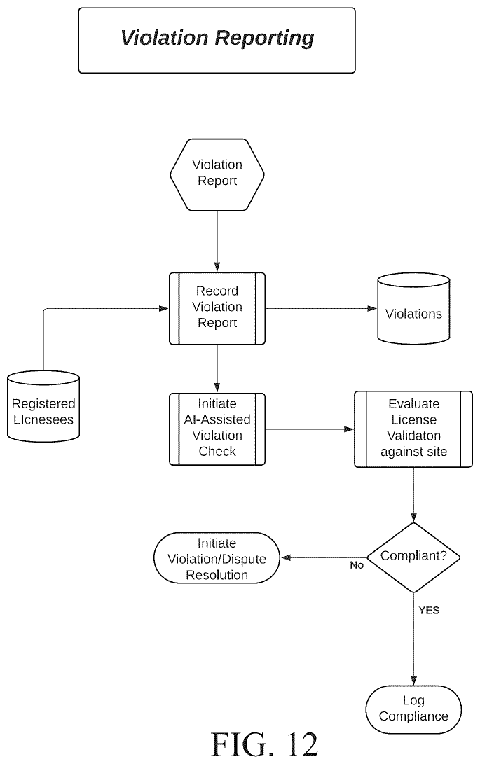

FIG. 12 shows an embodiment of a process flow for a violation reporting process, starting with a violation report, recording of such, initiation of AI-assisted violation checking, and evaluating license validation, and then logging that there is compliance or initiating violation dispute resolution.

### CERTAIN ADVANTAGES OF SOME PREFERRED EMBODIMENTS

This invention provides advanced systems and methods for digital rights management and content distribution that integrate blockchain technology, Non-Fungible Tokens (NFTs), and Artificial Intelligence (AI) to address the complexities and shortcomings inherent in traditional DRM systems. At its core, certain embodiments of this invention reimagine the approach to licensing digital content, offering a degree of precision, security, and adaptability previously unattainable.

One of the invention's foremost innovations is its use of blockchain technology to establish an immutable, transparent ledger for recording all transactions, license agreements, and content modifications. This approach not only ensures the integrity and auditability of digital rights transactions but also introduces a new level of transparency into the ecosystem. The immutable nature of blockchain records provides a trust foundation among participants, eliminating doubts about the authenticity and ownership of digital content, which are common concerns with centralized DRM solutions. It should be noted that centralized, managed ledger databases offering transparent, immutable approaches can also power this system.

Further enhancing preferred embodiments' robustness is the implementation of micro-licensing through NFTs. This feature allows for the tokenization of digital content, with each piece uniquely identified and associated with granular licensing terms directly embedded within the NFT metadata. Such granularity enables content creators to specify detailed rights and permissions for their work, from broad distribution rights to more restrictive use cases. This precision affords creators unparalleled control over their content, a stark contrast to the one-size-fits-all approach of many existing DRM models, which often lead to inefficiencies and disputes over rights usage.

The inclusion in certain embodiments of community-sourced licensing templates marks another significant departure from conventional DRM practices. By allowing the user community to develop, share, and select from a variety of licensing templates, the system democratizes the creation of licensing agreements. This participatory approach ensures that the templates evolve in line with the community's needs, offering a dynamic solution that traditional DRM systems, with their static and often outdated licensing models, cannot match.

The real-time nature of license distribution in certain preferred embodiments, facilitated by blockchain technology and AI, stands as a testament to their innovative edge. Licenses can be issued, transferred, and modified instantaneously, reflecting changes in content usage or ownership without the delays characteristic of manual processing. This immediacy enhances the market responsiveness of content creators and licensors, allowing them to capitalize on emerging opportunities and adapt to changing market conditions swiftly.

Furthermore, certain preferred embodiments of this invention introduce an unprecedented level of customization and flexibility through filterable licensing terms and authoritative endorsements. Content creators can fine-tune licensing agreements to match specific requirements, while endorsements from recognized authorities imbue digital artifacts with an additional layer of credibility and value. This ability to tailor and enhance content through verifiable endorsements offers a compelling advantage over traditional systems, where the verification of content authenticity and quality often remains a challenge.

The open market for digital content facilitated by certain preferred embodiments of this invention represent a radical shift towards transparency and equity in content distribution. By leveraging an open blockchain platform, these embodiments ensure that all transactions and licensing terms are visible to participants, fostering a transparent environment where fair competition can thrive. This openness is a marked improvement over the opaque practices of traditional DRM systems, where hidden agreements and restricted access to information can stifle market dynamics and innovation. In essence, certain embodiments of this invention embody a forward-thinking approach to digital rights management, leveraging cutting-edge technologies to overcome the limitations of existing DRM systems. Their emphasis on security, transparency, and adaptability not only addresses the current challenges faced by content creators and licensors but also paves the way for a more equitable, efficient, and dynamic digital content ecosystem.

Additionally, the advertisement verification model introduced here represents a groundbreaking advancement in the realm of digital advertising, addressing the pervasive challenge of ensuring advertisement authenticity and trustworthiness. At the heart of this model is the integration of blockchain technology, which serves as the foundation for creating an immutable and transparent ledger for advertisements and their endorsements. This not only guarantees the integrity of the advertisement's content over time but also provides a verifiable record of endorsements from trusted entities, elevating the credibility of advertisements to unprecedented levels.

One of the most significant advantages of this model is its capacity to fundamentally shift the dynamics of trust in digital advertising. By allowing consumers to directly verify the authenticity and endorsements of advertisements, it empowers them to make informed decisions, fostering a deeper sense of confidence in the digital ecosystem. This direct line of verification, facilitated by the immutable nature of blockchain records, stands in stark contrast to traditional advertising models, where claims can be difficult to authenticate and consumer trust is often eroded by the prevalence of misleading information.

Furthermore, the model innovates upon traditional advertising revenue structures through a reversed payment system, where advertisers compensate publishers for the privilege of placing their verified ads. This inversion not only aligns the economic incentives of publishers with the promotion of high-quality, truthful advertisements but also encourages advertisers to pursue verifiable endorsements actively, knowing that such validation enhances their access to premium advertising spaces.

Another novel aspect of this model is the application of smart contracts to automate the verification, publication, and payment processes associated with digital advertisements. These smart contracts ensure that all transactions and endorsements are executed in accordance with predefined criteria, eliminating manual oversight and reducing the potential for errors or fraud. The use of smart contracts in this context exemplifies how blockchain technology can streamline complex processes, making digital advertising more efficient and reliable.

In essence, the advertisement verification model enabled in this disclosure stands as a testament to the power of leveraging blockchain technology and smart contracts to enhance trust and integrity in digital advertising. By providing a robust framework for verifying advertisement content and endorsements, reversing traditional payment flows to prioritize content quality, and automating key processes to ensure efficiency and reliability, this model marks a significant leap forward in the digital advertising domain. It not only addresses current challenges but also paves the way for a future where transparency, credibility, and consumer trust are at the forefront of digital marketing strategies.

This invention introduces a groundbreaking framework that significantly elevates consumer awareness and control in the digital content landscape. This innovative approach extends beyond traditional security measures by empowering individuals and businesses to navigate online content with unparalleled precision and trust. Central to certain preferred embodiments of this invention is the development of systems and methods that allow content trustworthiness to be assessed and declared not just by publishers and advertisers but also verified by trusted endorsements, thereby weaving a complex tapestry of credibility that users can rely on for making informed decisions.

A novel aspect of certain preferred embodiments of this invention lies in its ability to operate with nuanced discretion at the content level, a departure from the binary, site-wide evaluations typically seen in existing digital security solutions. This granular control enables consumers to engage with online content based on a multifaceted understanding of its trustworthiness, which is dynamically adjustable according to the user's preferences and evolving standards of credibility. By implementing this model, these embodiments afford consumers the flexibility to tailor their digital environments to suit personal or organizational risk thresholds, interests, and ethical considerations.

Furthermore, the use of blockchain in certain embodiments, or potentially other cryptographic certificate technology for recording endorsements and content verifications, introduces a layer of transparency and immutability that significantly enhances trust in online interactions. This approach not only bolsters confidence in the authenticity of digital content but also establishes a verifiable ledger of trust for advertisements and published materials, enabling consumers to navigate the digital realm with confidence and discernment.

One of the most striking innovations of certain preferred embodiments of this invention are their departure from conventional security paradigms, which often focus on protecting users from external threats. Instead, these embodiments empower users to proactively shape their online experience based on content credibility, extending beyond mere security to foster a culture of informed content consumption and interaction. By granting users the ability to selectively filter, block, or receive warnings about content based on its trust level and source endorsements, these embodiments facilitate a personalized online environment where trust and security are seamlessly integrated.

The capabilities introduced by certain preferred embodiments of this invention represent a significant advancement in digital content management, offering individuals and businesses a sophisticated toolset for navigating the complexities of online trust. These embodiments stand as a testament to the potential of leveraging technology to enhance consumer autonomy, awareness, and control in the digital age, setting a new standard for content trust and security that is both comprehensive and user-centric.

The subject matter of this disclosure is now described with reference to the following examples. These examples are provided for the purpose of illustration only, and the subject matter is not limited to these examples, but rather encompasses all variations which are evident as a result of the teaching provided herein.

### Example I

### Real Estate Data Sharing

Specific challenges in the Real Estate industry are found in property listings. Today, this information is maintained by local area multiple listing services that are created by agents. This information is sometimes populated by public records, but is overridable by the agent authors. Not uncommonly, errors of omission and intentional misrepresentation are present to the degree that many MLSs have “compliance” departments comprised of many people manually responding to reports of bad information.

Some syndicators will improve this by adding information that may be conflicting in their informational sources, which is also costly, and, from the user's perspective, creates additional ambiguity. It is also a very non-standardized practice across the industry.

Many broker-agent-author-participants also have no recourse over compensation for their creative work, including composition when these artifacts are used for purposes other than the direct and sole purpose of advertising. For this use case, there is little venue open for rights assertion or compensation, attribution, or the specification of any terms that are not specifically negotiated.

Similarly, the sharing of this information is often used by other industry members such as financial institutions, insurance companies, trend analysis and more without any attainment of licensed use as this is seen as cost prohibitive by MLSs and the broker-agent-authors.

With the shift currently underway in the methods of compensation to brokers on behalf of consumers, a novel solution is the introduction of micro-licensing of these information artifacts whereby the author-creators can be compensated for their creative work on a per artifact basis.

Using blockchain affords several features that make the volume achievable without the current MLS model's inefficient use of manual processes and methods. Each artifact can be effectively and efficiently licensed as part of the replication process, subject to filters they specify, and still with a positive indication to accept the license.

Further, the license terms are advertised as a marketplace, so the terms themselves can be filtered as needed for costs, location, duration and other terms, including credibility.

With the introduction of Endorsements, authoritative bodies can provide details for these listing artifacts such that they are independent, non-biased, and tracible pieces of information, that are bound in the content's (listing, here) blockchain. This provides natural and valuable credibility for the artifacts so that consumers of the data can know the value and credibility of the artifact they are licensing.

Today, most data that is on a listing comes from public records, although overridable and without guarantee or disclosure of the source. With this model, any authority can participate, such as Home Owner Associations (HOAs) for accurate dues, school districts for school boundaries, and other fact curator vendors for school quality, environmental impact or measurement organizations and others.

Literally anyone can advertise their credentials, data and scope in an open marketplace for price and availability. This serves also to lower implementation costs for each of these would-be vendors as they would not need to integrate with the over 500 MLSs individually as they must today, and which is often futile from a contract perspective, as MLSs represent thousands of broker-agent consumers with different needs rendering it vastly impractical to offer to everyone.

The author the content, and indeed any endorser, are immediately compensated from any potential consumer of the information in a way that allows lower costs for brokers, or even unrepresented sellers and buyers, so that end consumers will enjoy lower costs for real estate transactions while still benefiting from richer, augmented and authoritative sources.

This model is easily extensible to any similar use case.

### Example II

### News and Non-Fiction Articles

In the evolving landscape of digital publishing, particularly for news and non-fiction articles, the challenge of protecting, managing, and monetizing content while ensuring accessibility and credibility has become increasingly pronounced. Traditional publishing mechanisms, which often rely on simple bylines or publisher attribution, fall short in addressing the nuanced demands of digital content distribution, including copyright protection, flexible licensing, and the validation of content authenticity. The system outlined in this patent offers a comprehensive solution that fundamentally enriches and improves the digital publishing arena by leveraging blockchain technology, NFTs, and AI. This detailed explanation explores the multifaceted benefits this system brings to electronically published news and non-fiction articles over conventional methods.

### Enhanced Copyright Protection and Provenance Tracking

The use of NFTs to tokenize news articles and non-fiction content ensures each piece is uniquely identified and its ownership indisputably established on the blockchain. This not only provides robust copyright protection but also facilitates detailed provenance tracking, allowing readers and publishers to trace the content's origin, ownership history, and any changes or updates it may have undergone. Unlike traditional publishing that offers limited protection and tracking capabilities, this system ensures that content creators retain control over their work, preventing unauthorized use and reproduction.

### Dynamic and Flexible Licensing

Through micro-licensing capabilities, the system empowers content creators and publishers to define precise usage rights for their articles, from complete access to restricted viewing or citation rights. These licenses, embedded directly within the NFT metadata, can be customized to suit various distribution strategies, such as pay-per-view, subscription models, or free access under certain conditions. This flexibility significantly surpasses the one-dimensional licensing options of conventional publishing, enabling content providers to innovate in content monetization and distribution while ensuring legal compliance.

### Verifiable Authoritative Endorsements

The integration of authoritative endorsements directly into the content's NFT metadata introduces an unprecedented layer of credibility to news and non-fiction articles. Recognized experts or entities can verify the accuracy and reliability of the content, with these endorsements becoming an immutable part of the content's record. This feature is a game-changer in an era marked by concerns over misinformation, offering readers a verifiable means to trust the content's integrity, something traditional publishing struggles to provide.

### Real-Time Content Management and Distribution

Blockchain and AI technologies enable real-time updates to content and licensing terms, allowing publishers to respond swiftly to evolving news cycles and reader demands. This system facilitates instant distribution of updated or new content to subscribers, a marked improvement over traditional methods where updates may be delayed or lost in the noise of internet publishing. Furthermore, the automated detection of licensing violations using AI and digital fingerprinting ensures that content misuse is promptly addressed, maintaining the integrity and value of the published work.

### Transparent Revenue Sharing and Monetization

Smart contracts automate revenue distribution according to predefined agreements, ensuring transparent and fair compensation for content creators and contributors. This mechanism supports innovative revenue models, such as dynamic pricing based on article popularity or impact, directly rewarding quality and engagement. Traditional publishing models often lack this level of transparency and flexibility in revenue sharing, potentially leaving content creators undercompensated.

### Open Market for Content Accessibility

Creating an open marketplace for news and non-fiction articles democratizes content accessibility, allowing independent journalists and authors to reach audiences without the intermediation of large publishers. This open market ensures that quality content finds its audience, fostering a diverse and vibrant digital publishing ecosystem.

In sum, these systems and methods significantly enrich and improve the digital publishing landscape for news and non-fiction articles. By providing robust copyright protection, flexible licensing, enhanced credibility through endorsements, real-time content management, transparent revenue sharing, and an open marketplace for content, they address the critical challenges of conventional publishing methods. They empower content creators, publishers, and consumers alike, paving the way for a more equitable, efficient, and trustworthy digital publishing future.

### Example III

### How-To and Instructional Content

The digital age has transformed how knowledge is disseminated, with how-to and instructional content becoming vital resources for learners worldwide. However, this digital transformation also brings challenges in copyright protection, content credibility, monetization, and distribution. Traditional publishing methods, often limited to a byline or publisher's mark, are insufficient for the dynamic nature of online educational content. The systems and methods disclosed herein revolutionize the publication of how-to and instructional content on the internet through their innovative use of blockchain technology, Non-Fungible Tokens (NFTs), and Artificial Intelligence (AI). This disclosure shows how these systems and methods offer significant improvements over conventional methods, enhancing both the creation and consumption of educational content.

### Enhanced Copyright Protection and Content Authenticity

Utilizing NFTs for how-to and instructional content not only secures copyright ownership but also embeds a tamper-proof record of the content's origins and updates. Unlike traditional methods that struggle with rampant unauthorized distribution and plagiarism, this system ensures that each piece of content is uniquely identifiable and protected. Creators can easily prove ownership, and users can verify the authenticity, fostering a trustworthy digital educational ecosystem.

### Dynamic Licensing and Broadened Access

The micro-licensing model introduced by this system allows content creators to specify flexible and precise usage rights. Whether offering content for free, under a pay-per-view scheme, or through subscription access, creators have unparalleled control over how their instructional materials are distributed. This flexibility extends the reach of educational content, making it accessible to a wider audience and accommodating diverse learning needs and economic circumstances, a stark contrast to the rigid licensing of conventional publishing.

### Authoritative Endorsements for Enhanced Credibility

In the realm of how-to and instructional content, credibility is paramount. This system's feature of incorporating endorsements directly into the NFT metadata means that educational content can be verified by experts or accrediting bodies, enhancing its value and reliability. Learners gain confidence in the quality of the information, knowing it has been endorsed by authorities in the field, a significant improvement over traditional publishing, where verifying the accuracy and currency of information can be challenging.

### Real-Time Updates and Adaptability

The blockchain-based system enables content creators to update their instructional materials in real-time, ensuring learners have access to the most current and relevant information. This adaptability is crucial for how-to content, which may need frequent updates to remain accurate. Smart contracts automate these updates, and AI algorithms can suggest improvements or identify areas needing revision, capabilities far beyond the reach of conventional publishing methods.

### Transparent and Fair Monetization

Through smart contracts, this system implements transparent revenue-sharing models that fairly compensate content creators and contributors based on predefined terms. This model encourages the production of high-quality instructional content by directly linking creator compensation to content usage and popularity. Such transparent monetization mechanisms are often lacking in traditional publishing, where revenue distribution can be opaque and unfairly skewed.

### Open Marketplace for Instructional Content

By facilitating an open marketplace for how-to and instructional content, the system democratizes access to educational materials. Independent creators can reach audiences directly, bypassing traditional gatekeepers of knowledge such as publishing houses or educational institutions. This open market fosters a rich diversity of content, empowering learners to access a wide array of materials tailored to their specific learning goals and interests.

In sum, these systems and methods significantly enhance the landscape of how-to and instructional content on the internet. By addressing critical issues around copyright protection, content credibility, flexible distribution, real-time updates, fair monetization, and democratized access, they represent a profound shift away from conventional publishing. Creators are empowered to produce and update their work securely and efficiently, while learners benefit from access to a diverse, credible, and up-to-date educational resource pool. This not only enriches the digital educational content ecosystem but also sets a new standard for how knowledge is shared and consumed in the digital age.

### Example IV

### Articles and Claims of Political Nature

In the digital era, the rapid dissemination of information online has transformed the landscape of political discourse, election coverage, and public awareness. However, this transformation has also ushered in challenges, notably the proliferation of misinformation and “fake news.” Traditional publishing mechanisms, even with attempts at automated fact-checking, often fall short in effectively curbing the spread of inaccuracies, primarily due to their reliance on reactive rather than proactive measures, and the lack of verifiable source credibility. The patented system described herein introduces a revolutionary approach to managing political claims, election coverage, and combating “fake news” through its innovative use of blockchain technology, Non-Fungible Tokens (NFTs), and Artificial Intelligence (AI). This disclosure shows how these systems and methods offer substantive improvements over conventional methods, significantly enhancing the integrity and reliability of online political content.

### Immutable Record-Keeping and Source Verification

The cornerstone of these embodiments are the blockchain infrastructure, which provides an immutable ledger for all content, ensuring that once information is published, its origin and any subsequent modifications are permanently recorded and easily traceable. This feature is critical in political reporting and election coverage, where the accuracy of information and the timeline of events can have profound implications. Unlike conventional publishing, where retractions and edits might not receive the same visibility as the original misinformation, this system ensures that the history of each piece of content is transparent and accessible, fostering accountability among publishers and trust among readers.

### Endorsement and Verification Mechanism

An important aspect of these embodiments is the integration of authoritative endorsements directly into the NFT metadata of published content. This mechanism allows for political claims and election-related content to be verified by recognized experts or institutions before being widely disseminated. Readers can easily verify these endorsements, distinguishing credible information from “fake news.” This proactive approach to validating content integrity vastly surpasses traditional reactive fact-checking methods, which often struggle to stem the tide of misinformation once it has spread.

### AI-Enhanced Content Analysis

Leveraging AI, the system offers advanced content analysis capabilities, including automated fact-checking against verified databases and historical records. This AI-driven approach not only screens content for potential inaccuracies before publication but also identifies and flags content that may be misleading or taken out of context. By automating the verification process, the system significantly reduces the time and resources required to maintain content accuracy, a task that conventional publishing methods find increasingly challenging in the fast-paced digital news environment.

### Dynamic Content Management

Through the use of smart contracts, these embodiments enable dynamic content management, allowing for real-time updates or corrections to be made to political content and election coverage. This feature ensures that the most current and accurate information is always available to the public, a marked improvement over traditional publishing, where outdated or incorrect information may linger uncorrected.

### Transparent and Open Content Marketplace

The system facilitates an open marketplace for political content, where articles and reports are tokenized as NFTs. This marketplace not only makes political content more accessible but also more accountable. Publishers and journalists are incentivized to produce high-quality, verified content, knowing that their reputation and the credibility of their work are openly scrutinized and can be traced back through the blockchain ledger.

In sum, these systems and methods significantly advance the field of digital publishing concerning political claims, election coverage, and the fight against “fake news.” By providing robust tools for immutable record-keeping, content endorsement and verification, AI-enhanced analysis, dynamic content management, and fostering an open content marketplace, they offer a proactive and comprehensive solution to the challenges of misinformation. This system not only enriches the digital landscape for political discourse but also sets a new standard for accuracy, credibility, and trust in online information, far surpassing the capabilities of conventional publishing and automated fact-checking methods.

### Example V

### Advertisements

In the vast expanse of the digital advertising world, distinguishing between genuine and misleading advertisements presents a formidable challenge, undermining the foundational trust between consumers, advertisers, and publishers. Traditional approaches to ensuring the veracity of online advertisements—relying primarily on publisher oversight or reactive automated fact-checking mechanisms—have proven insufficient in the face of increasingly sophisticated deceptive marketing strategies. The innovative system described in this disclosure, leveraging blockchain technology, Non-Fungible Tokens (NFTs), and Artificial Intelligence (AI), proposes a groundbreaking solution to these persistent challenges. These embodiments not only facilitate a more reliable vetting process for advertisements but also reimagine the economic interactions between advertisers and publishers, ensuring a trustworthy advertising ecosystem. Below is an in-depth disclosure of how these embodiments enhance truth in advertising and redefine ad revenue models to benefit all parties involved.

### Immutable Certification and Verification of Advertisements

Central to these embodiments is the application of blockchain technology to create an immutable, transparent ledger for each advertisement. Ads are tokenized as NFTs, each assigned a unique digital fingerprint that details their content, origins, and any modifications they undergo. This unalterable record ensures that advertisers can certify the authenticity and accuracy of their ads, and publishers can select advertisements with confidence, knowing that each one has been permanently vetted and verified against established truthfulness criteria. Unlike traditional methods, which often leave ambiguity around ad content changes and claims, this blockchain-based approach guarantees a level of transparency and accountability previously unattainable.

### AI-Driven Content Analysis and Real-Time Vetting

These embodiments employ AI algorithms to analyze and vet advertisements against verified data sources, benchmarks, and historical advertising records. This analysis includes real-time evaluation of claims made within ads, significantly reducing the likelihood of false or misleading content reaching consumers. By automating the vetting process, these embodiments allow publishers to confidently select and publish ads that meet high standards of truthfulness and integrity, thereby protecting their reputation and the trust of their audience.

### Reversal of Payment Models and Trust in Advertisers

An important aspect of these embodiments are their ability to reconfigure their resources from content creators being compensated by publishers. Rather, using the same infrastructure, the traditional advertisement model is facilitated wherein these embodiments facilitate advertisers paying publishers. However, these embodiments also go beyond ad placement, and also maintain the integrity of the advertising content. In these embodiments, ads certified through their rigorous vetting process are eligible for publication, and publishers receive payments for hosting these certified ads. This reversal ensures that publishers have a vested interest in selecting only the highest quality, verified advertisements, aligning economic incentives with the goal of promoting truth in advertising.

This allows a faster ad-to-market model with real-time acceptance of ads pre-certified by endorsers that publishers trust. In this manner, the costs associated with individual content approval are lower and completed once. The approval is verifiable by the publisher through an immutable endorsement on the blockchain or cryptographic technology. The filterable subscriptions allow publishers to see content advertised and trust that the content meets their requirements. These requirements can then be advertised by the site with assurance to the consumer that the content will be appropriate.

### Consumer Benefits and Enhanced Trust

For consumers, these embodiments offer a transformative improvement in the reliability of online advertisements. By ensuring ads are certified for truthfulness, consumers can make more informed decisions based on advertising content. The transparency afforded by the blockchain ledger means that consumers can trace the origins and certification status of advertisements, further enhancing trust in both the ads they see and the publishers that host them.

In addressing the pervasive issue of false advertising and rebuilding the eroded trust among consumers, advertisers, and publishers, these embodiments present a comprehensive, technologically advanced solution. By certifying advertisements on a blockchain, employing AI for real-time ad vetting, and innovating the economic model between advertisers and publishers, these embodiments set a new standard for truth in advertising. Publishers gain confidence in the ads they select, advertisers benefit from a trusted platform for their messages, and consumers enjoy a safer, more transparent online environment. This ecosystem not only enriches the digital advertising space but also redefines it for the better, ensuring integrity and trust are at the forefront of online advertising.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

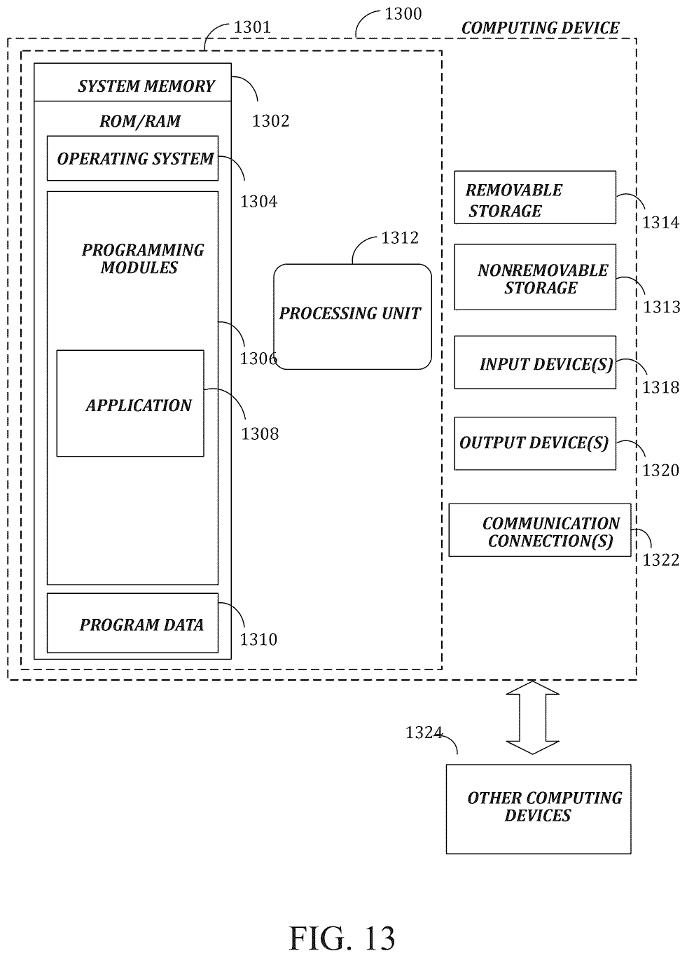

FIG. 13 is a block diagram illustrating an exemplary computing device 1300 that may be used to implement various aspects of the invention. The device 1300 includes a processing unit 1312, a system memory 1301, and a system bus 1313 that couples various system components including the system memory to the processing unit 1312. The system memory 1301 includes read-only memory (ROM) 1302 and random access memory (RAM) 1302. A basic input/output system 1303 (BIOS), containing the basic routines that help to transfer information between elements within the computer 1300, such as during start-up, is typically stored in ROM 1302.

The computer 1300 may include a hard disk drive 1314 for reading from and writing to a hard disk, a magnetic disk drive 1316 for reading from or writing to a removable magnetic disk 1317, and an optical disk drive 1318 for reading from or writing to a removable optical disk 1319 such as a CD-ROM or other optical media. The hard disk drive 1314, magnetic disk drive 1316, and optical disk drive 1318 are connected to the system bus 1313 by a hard disk drive interface 1320, a magnetic disk drive interface 1322, and an optical drive interface 1324, respectively. A number of program modules may be stored on the hard disk, magnetic disk 1317, optical disk 1319, ROM 1302 or RAM 1302, including an operating system 1304, one or more application programs 1306, other program modules 1308, and program data 1310. A user may enter commands and information into the computer 1300 through input devices such as a keyboard 1326 and pointing device 1327, such as a mouse.

The computer 1300 may operate in a networked environment using logical connections to one or more remote computers, such as a remote computer 1329. The remote computer 1329 may be another personal computer, a server, a router, a network PC, a peer device or other common network node, and typically includes many or all of the elements described above relative to the computer 1300.

Other programming modules that may be used in accordance with embodiments of the present disclosure may include electronic mail and contacts applications, word processing applications, spreadsheet applications, database applications, slide presentation applications, drawing or computer-aided application programs, etc., Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

In further embodiments of this invention, the micro-licensing system may be implemented in various configurations to accommodate different use cases, technological environments, and user requirements. These embodiments expand upon the core functionality while maintaining the fundamental principles of blockchain-based content licensing, smart contract automation, and AI-enhanced compliance monitoring.

### Hybrid On-Chain/Off-Chain Implementation

The system may be implemented as a hybrid solution where certain critical transactions and metadata are stored on-chain while larger content files and auxiliary data are maintained off-chain. In this embodiment, content fingerprints, license terms, and transaction records may be stored on the blockchain to ensure immutability and transparency, while the actual content files may be stored in decentralized storage solutions such as IPFS (InterPlanetary File System) or centralized cloud storage. This approach may optimize for cost efficiency and scalability while maintaining the security and transparency benefits of blockchain technology.

The smart contracts in this hybrid model may contain pointers or references to the off-chain storage locations, along with cryptographic hashes to verify content integrity. When a user accesses licensed content, the system may verify the license status on-chain and then facilitate retrieval from the appropriate storage solution. This embodiment may be particularly beneficial for handling large media files, such as high-resolution images, videos, or extensive documents, where on-chain storage would be prohibitively expensive.

### Private Blockchain Implementation

For organizations with specific privacy requirements or regulatory constraints, the system may be implemented on a private or permissioned blockchain network. In this embodiment, only authorized participants may access the network and view transaction details. This approach may be suitable for industries handling sensitive information, such as healthcare, legal services, or financial institutions, where content confidentiality is paramount.

Private blockchain implementations may offer additional control over network participants, consensus mechanisms, and governance structures. Organizations may establish their own rules for content licensing, endorsement requirements, and dispute resolution processes, tailored to their specific needs and compliance requirements. Integration with existing identity management systems may provide seamless authentication and authorization for users within the organization's ecosystem.

### Cross-Chain Compatibility

To enhance interoperability and reach, the system may support cross-chain functionality, allowing licenses and content to be managed across multiple blockchain networks. This embodiment may employ cross-chain bridges or relay mechanisms to facilitate communication between different blockchain ecosystems, such as Ethereum, Polkadot, or Solana.

Cross-chain compatibility may enable users to leverage the specific advantages of different blockchain networks while maintaining a unified licensing framework. For example, a content creator may issue licenses on a high-security network while enabling faster, lower-cost transactions for certain types of content on a more scalable network. Smart contracts may be designed to recognize and validate licenses across these different chains, ensuring consistent enforcement of terms regardless of the underlying blockchain infrastructure.

### Mobile-First Implementation

Recognizing the prevalence of mobile device usage, the system may be optimized for mobile interfaces, providing a streamlined experience for content creators, endorsers, and consumers on smartphones and tablets. This embodiment may include mobile applications with intuitive interfaces for managing licenses, reviewing endorsements, and accessing licensed content.

Mobile implementations may leverage device-specific features such as biometric authentication for secure access, push notifications for real-time updates on license status or endorsement requests, and offline capabilities for accessing previously licensed content without constant network connectivity. Integration with mobile payment systems may facilitate seamless transactions, making micro-licensing accessible to a broader audience.

### Enterprise Integration Framework

For large organizations and corporate environments, the system may include robust integration capabilities with existing enterprise systems such as content management systems (CMS), digital asset management (DAM) platforms, customer relationship management (CRM) tools, and enterprise resource planning (ERP) systems.

This embodiment may provide APIs, webhooks, and middleware components to facilitate seamless data exchange between the micro-licensing platform and enterprise systems. For example, content created in a DAM system may be automatically fingerprinted and prepared for licensing, while license transactions may be synchronized with financial systems for accounting and reporting purposes. Integration with identity and access management (IAM) systems may ensure that licensing activities align with organizational roles and permissions.

### Decentralized Autonomous Organization (DAO) Governance

The system may incorporate DAO governance mechanisms, allowing stakeholders to collectively manage and evolve the licensing ecosystem. In this embodiment, token holders may propose and vote on changes to system parameters, fee structures, endorsement criteria, or dispute resolution processes.

DAO governance may provide a transparent and participatory approach to managing the licensing platform, ensuring that it remains responsive to the needs of its user community. Smart contracts may automate the implementation of approved proposals, reducing administrative overhead and potential conflicts. This model may be particularly suitable for community-driven content platforms, industry consortia, or collaborative creative ecosystems.

### Subscription-Based Licensing Models

Beyond one-time licensing transactions, the system may support subscription-based models where users pay recurring fees for ongoing access to content collections or services. Smart contracts may automate subscription management, including periodic payments, access control, and renewal processes.

This embodiment may include features such as tiered subscription levels with different access rights, flexible billing cycles, trial periods, and automatic renewals. Content creators may offer bundled subscriptions covering multiple content types or collaborate with other creators to provide comprehensive packages. The blockchain-based approach ensures transparent tracking of subscription status and usage rights, reducing disputes and unauthorized access.

### AI-Enhanced Content Recommendation

Building upon the AI capabilities for compliance monitoring, the system may incorporate recommendation engines that suggest relevant content to users based on their licensing history, preferences, and behavior patterns. This embodiment may leverage machine learning algorithms to analyze user interactions and content characteristics, providing personalized recommendations for potential licensing opportunities.

For content creators, AI recommendations may identify potential collaborators, endorsers, or marketing strategies based on market trends and user engagement patterns. For consumers, the system may suggest relevant content that aligns with their interests and licensing preferences, facilitating discovery and increasing the value of the platform ecosystem.

### Regulatory Compliance Frameworks

For industries subject to specific regulatory requirements, the system may include specialized compliance frameworks that ensure licensing activities adhere to relevant laws and standards. This embodiment may incorporate built-in compliance checks, audit trails, and reporting capabilities tailored to specific regulatory environments.

For example, in the real estate industry, the system may include features to ensure compliance with fair housing laws, disclosure requirements, and licensing regulations. In the financial sector, compliance with anti-money laundering (AML) and know-your-customer (KYC) regulations may be integrated into the licensing process. The immutable nature of blockchain records provides a reliable audit trail for demonstrating compliance to regulatory authorities.

### CONCLUSION

These additional embodiments illustrate the versatility and adaptability of the micro-licensing system, demonstrating how it may be tailored to address diverse requirements across different industries, technological environments, and user contexts. By combining blockchain-based security, smart contract automation, and AI-enhanced monitoring with these specialized implementations, the system may provide comprehensive solutions for managing digital content rights in an increasingly complex and dynamic digital ecosystem.

While maintaining the core principles of transparency, security, and efficiency, these embodiments extend the system's capabilities to address specific challenges and opportunities in various domains. The modular architecture of the system allows for flexible adoption of these features, enabling users to select the combination that best suits their particular needs and objectives.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112 (f), unless the element is expressly recited using the exact phrase “means for . . . ” and no method or process step herein is to be construed under the provisions of 35 U.S.C. section 112 (f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. It is to be understood that the foregoing description is not intended to limit the scope of the present disclosure. The present disclosure contemplates numerous variations, modifications, and adaptations that will become apparent to those skilled in the art upon reading and understanding the foregoing description. The scope of the present disclosure is defined by the appended claims and their legal equivalents.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for managing digital content use and rights associated with such digital content, for creators and users of such digital content, the method comprising:
a. verifying credential information of the creators and users in connection with their use of the digital content;
b. storing digital artifacts relating to the digital content for later access distribution;
c. issuing licenses to the digital content to users by employing smart contracts on a blockchain for containing terms of the licenses,
d. managing terms of the licensing, the managing the terms of the licensing comprising (i) handling of any payments for the licensing, (ii) handling of any royalties owed, (iii) enforcing licensing terms, (iv) revoking expired or non-compliant licenses, (v) updating licenses terms, (vi) managing updated digital content and matching updated digital content with user subscriptions, (vii) managing push notifications of changes to the licensing to users, and (viii) automating adjustments and renewals of the licensing;
e. recording every transaction associated with the use of the digital content with the smart contracts on the blockchain, thereby creating an immutable audit trail; and
f. providing for endorsements for transactions.

2. The method of claim 1 wherein the digital content is an advertisement. a real estate listing, a real estate document, a research publication, a political statement, a news article, or instructions.

3. A method of managing digital content, the method comprising:
a. tokenizing the digital content as a unique Non-Fungible Token;
b. establishing a transparent, verifiable ledger for each digital content with a smart contract on a blockchain, the Non-Fungible Token, and artificial intelligence;
c. providing license templates with license terms for the digital content;
d. choosing a license template for the digital content with experts in a community that contributes to and votes on the template;
e. embedding the license terms chosen in the smart contract on the blockchain;
f. endorsing the digital content and transactions with the license with experts in a community that contributes to and votes on the endorsements, said endorsements stored on the blockchain;
g. verifying in real-time the digital content against established benchmarks;
h. certifying the digital content that meets the established benchmarks;
i. licensing the digital content using the licensing terms; and
j. monitoring and learning from the use of the digital content to detect licensing violations and automate disposition of such violations.

4. A method of managing digital content and rights associated with such digital content, the method comprising:
a. issuing micro-licenses to the digital content and rights upon distribution of the digital content and rights to users with user subscriptions;
b. storing the micro-licenses in smart contracts on blockchain; and
c. updating the smart contrasts by (i) aligning the user subscriptions to the micro-licenses, (ii) dynamically adjusting the smart contracts in real-time to reflect digital content revisions; and (iii) continuously aligning users' preferences and legal compliance through transparent and auditable blockchain records on the blockchain.

5. A method for managing and distributing digital content, the method comprising:
a. micro-licensing the digital content;
b facilitating transparent, flexible and secure transactions and interactions with the digital content with smart contracts within a blockchain framework;
c. creating and selecting licensing templates with community participation and authoritative endorsements to verify the content of the digital content;
d. employing AI to automate compliance monitoring and enforcement of licensing terms;
e. automating violation management process using blockchain-recorded evidence and AI driven decision making; and
f. accepting contract terms through interaction with push notifications.

6. A method of addressing licensing concerning evolving digital content by providing a secure, transparent and efficient method of digital rights management and tailored distribution and continuous updating of content.

7. A method of managing digital rights, the method comprising:
a. tokenizing the digital rights by employing a Non Fungible Token to tokenize the digital rights, thereby ensuring each piece of digital content is uniquely identified;
b. embedding flexible, transparent licensing terms to the digital rights within the Non Fungible Token;
c. storing the Non Fungible Tokens (NFT) in smart contracts on a blockchain;
d. developing community-driven licensing templates for the digital rights; and
e. obtaining authoritative endorsements to validate the digital rights accuracy and/or authenticity, with such endorsements being recorded within the NFT.

8. A method for managing digital content, the method comprising:
a. assigning an NFT to the digital content;
b. creating community-curated licensing templates for the digital content;
c. obtaining authoritative endorsements stored in the NFT; and
d. applying AI to detect and enforce any violations.

9. A system for managing digital content and rights, the system comprising computer-executable instructions stored on one or more computer servers, the instructions providing for multiple components, the components comprising:
a. a blockchain, the blockchain comprising a ledger for recording digital content and rights licenses, transactions, and endorsements, the blockchain providing transparency, security and immutability, the blockchain further comprising smart contracts;
b. licensing templates for the digital contact and rights using Non Fungible Tokens, wherein the digital content and rights are tokenized within the Non Fungible Token (NFT), and the Non Fungible Tokens provide management of licensing terms, ownership tracking and transaction history within the NFT meta-data stored in the smart contracts, and wherein the licensing templates are community-driven licensing templates and provide an empowered community to contribute to and select from a library of pre-defined licensing templates providing standardization and flexibility to accommodate diverse use cases and preferences;
c. authoritative endorsements that incorporate a mechanism for digital content to be verified and endorsed by recognized authorities or experts, such endorsements being embedded with the NFTs, and the authoritative endorsements providing enhanced credibility and market value of the digital content;
d. artificial intelligence and machine learning to automate detection of licensing term violations and to adapt enforcement strategies and providing effective compliance and rights management for the digital content;
e. automated violation management for handling licensing violations using blockchain records for evidence and artificial intelligence to determine a most appropriate reactions and providing improved efficiency and fairness in dispute resolution;
f. customized licensing wherein licensors can customize terms on top of the selected templates and adjust licensing agreement in response to changes in digital content usage and/or market conditions;
g. content marketplace creation facilitated to buy, sell or license the digital content supported by the blockchain to ensure fair and secure transactions; and
h. implemented smart contract-based revenue distribution models that provide fair compensation for content creators, licensors, and endorsers based on agreed terms.

10. A method of managing a digital advertisement, the method comprising:
a. tokenizing the digital advertisement as an NFT, the NFT comprising metadata;
b. endorsing the digital advertisement using blockchain, a smart contract, and real-time verification; and
c. monitoring and enforcing compliance using AI.

11. A method for real-time micro-licensing of digital content and rights.

12. A method of managing a digital record, the method comprising:
a. creating a digital artifact for the digital record using licensing templates;
b. recording the digital artifact in a smart contract on blockchain;
c. entering into a subscription for the digital artifact using a notification push service;
d. licensing the digital record using the smart contract;
e. updating the digital artifact with any changes to the digital record according to the smart contract;
f. endorsing the digital artifact according to the smart contract; and
g. revoking the license to the digital record according to the smart contract.

13. A method of managing trustworthiness of an ad, the method comprising:
a. creating a digital artifact for the ad;
b requesting a trusted ad service for the ad, the service comprising a smart contract on a blockchain, the smart contract comprising a trusted content policy;
c. applying the trusted content policy to the digital artifact to obtain results that confirm or deny the trustworthiness of the ad;
d. recording the applying of the trusted content policy and the results on the blockchain; and
e. sending a notification of the results.

14. The method of claim 13, wherein the digital artifact is stored in the metadata of a Non Fungible Token (NFT).

15. The method of claim 13, wherein the applying the trusted content policy to the digital artifact is confirmed by a trusted endorser.

16. A method for automated verification of a license to digital content, the method comprising:
a. creating a digital artifact for the digital content;
b choosing a license template comprising license terms for the digital artifact, and storing the license template in a smart contract on blockchain;
c. requesting a verification of the license, the requesting being done by a requester;
d. verifying the license comprises using the digital artifact and the smart contract and obtaining results as to whether the license is compliant or non-compliant;
e. logging the results on the blockchain; and
f. sending a notification of the results to the requester.

17. The method of claim 16, wherein the digital artifact is stored in metadata of a Non Fungible Token (NFT).

18. The method of claim 16, wherein the verifying is confirmed by a trusted endorser.

19. The method of claim 16, wherein the verifying further comprises using machine learning to (i) check for compliance using html scrapes for required attribution and other license terms; and (ii) check for compliance by looking for anomalous displays of licensed content, including any unauthorized use.

20. The method of claim 16, further comprising using artificial intelligence assisted verification and dispute resolution of non-compliant licenses.
